(19) United States
(12) Patent Application Publication
(10) Pub. No.: US 2023/0344582 A1
(43) Pub. Date: Oct. 26, 2023

(54) PILOT TRANSMISSION METHOD AND APPARATUS, DEVICE, AND STORAGE MEDIUM

(71) Applicant: VIVO MOBILE COMMUNICATION CO., LTD., Dongguan (CN)

(72) Inventors: Pu YUAN, Dongguan (CN); Dajie JIANG, Dongguan (CN); Hao LIU, Dongguan (CN); Bule SUN, Dongguan (CN)

(73) Assignee: VIVO MOBILE COMMUNICATION CO., LTD., Dongguan (CN)

(21) Appl. No.: 18/212,709

(22) Filed: Jun. 21, 2023

Related U.S. Application Data
(63) Continuation of application No. PCT/CN2021/141352, filed on Dec. 24, 2021.

(30) Foreign Application Priority Data
Dec. 25, 2020 (CN) 202011567155.5

(51) Int. Cl. H04L 5/00; H04L 27/26

(52) U.S. Cl. CPC H04L 5/0048; H04L 27/261

(57) ABSTRACT

A pilot transmission method and apparatus, a device, and a storage medium are provided. The method is performed by a target communication device, including: determining a target configuration parameter of a pilot; and mapping, based on the target configuration parameter, the pilot to a pilot resource block in a delay-Doppler domain for transmission.

### CROSS-REFERENCE TO RELATED APPLICATIONS

This application is a continuation of International Application No. PCT/CN2021/141352, filed Dec. 24, 2021, which claims priority to Chinese Patent Application No. 202011567155.5, filed Dec. 25, 2020. The entire contents of each of the above-referenced applications are expressly incorporated herein by reference.

### TECHNICAL FIELD

This application pertains to the field of communications technologies, and specifically relates to a pilot transmission method and apparatus, a device, and a storage medium.

### BACKGROUND

During channel estimation in an Orthogonal Time Frequency (OTFS) modulation system, a transmit end maps a pilot pulse to a delay-Doppler domain, a receive end estimates a channel response in delay-Doppler domain by analyzing a delay-Doppler image of a pilot, and further, a channel response expression in time-frequency domain can be obtained. This facilitates use of a conventional technology in time-frequency domain for signal analysis and processing. Therefore, in an actual system, performance of pilot signal detection is closely related to a pilot.

In the prior art, pilot sequence processing is required during pilot transmission which may lead to excessive pilot overheads or low pilot reliability.

### SUMMARY

Embodiments of this application provide a pilot transmission method and apparatus, a device, and a storage medium, to reduce excessive pilot overheads or improve pilot reliability.

According to a first aspect, a pilot transmission method is provided. The method is applied to a target communication device and includes:
determining a target configuration parameter of a pilot; and
mapping, based on the target configuration parameter, the pilot to a pilot resource block in delay-Doppler domain for transmission.

According to a second aspect, a pilot transmission apparatus is provided. The apparatus is applied to a target communication device and includes:
a first determining module, configured to determine a target configuration parameter of a pilot; and
a first transmission module, configured to map, based on the target configuration parameter, the pilot to a pilot resource block in delay-Doppler domain for transmission.

According to a third aspect, a target communication device is provided. The target communication device includes a processor, a memory, and a program or instructions stored in the memory and capable of running on the processor. When the program or instructions are executed by the processor, the steps of the pilot transmission method according to the first aspect are implemented.

According to a fourth aspect, a readable storage medium is provided. The readable storage medium stores a program or instructions. When the program or instructions are executed by a processor, the steps of the pilot transmission method according to the first aspect are implemented.

According to a fifth aspect, a chip is provided. The chip includes a processor and a communication interface. The communication interface is coupled to the processor. The processor is configured to run a program or instructions to implement the steps of the pilot transmission method according to the first aspect.

According to a sixth aspect, an embodiment of this application provides a computer program product. The program product is stored in a non-volatile storage medium. The program product is executed by at least one processor to implement the steps of the method according to the first aspect.

According to a seventh aspect, an embodiment of this application provides a communication device. The communication device is configured to perform the steps of the method according to the first aspect.

In the embodiments of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

### BRIEF DESCRIPTION OF DRAWINGS

FIG. 1 is a block diagram of a wireless communications system according to an embodiment of this application;

FIG. 2 is a schematic diagram of mutual conversion between a delay-Doppler domain and a time-frequency plane according to an embodiment of this application;

FIG. 3 is a schematic diagram of a channel response relationship in different planes according to an embodiment of this application;

FIG. 4 is a schematic flowchart of processing at a transmit end and a receive end in an OTFS multi-carrier system according to an embodiment of this application;

FIG. 5 is a schematic diagram of a pilot mapping in delay-Doppler domain according to an embodiment of this application;

FIG. 6 is a schematic diagram of pilot position detection at a receive end according to an embodiment of this application;

FIG. 7 is a schematic diagram of mappings of multi-port reference signals in delay-Doppler domain according to an embodiment of this application;

FIG. 8 is a schematic diagram of pilot resource reuse in delay-Doppler domain according to an embodiment of this application;

FIG. 9 is a schematic diagram of pilot sequence detection according to an embodiment of this application;

FIG. 10 is a schematic diagram of performance comparison of two pilot design schemes under different pilot overhead conditions according to an embodiment of this application;

FIG. 11 is a schematic flowchart of a pilot transmission method according to an embodiment of this application;

FIG. 12 is a schematic diagram of a relationship between a pilot base sequence, an orthogonal cover code, and a pilot according to an embodiment of this application;

FIG. 13 is a schematic flowchart for inserting a pilot in delay-Doppler domain according to an embodiment of this application;

FIG. 14 is a schematic diagram of pilot signal blocks overlap-mapped to a pilot resource block according to an embodiment of this application;

FIG. 15 is a first schematic diagram of a method for adjusting a target configuration parameter according to an embodiment of this application;

FIG. 16 is a second schematic diagram of a method for adjusting a target configuration parameter according to an embodiment of this application;

FIG. 17 is a first schematic diagram of a shape of a pilot resource block according to an embodiment of this application;

FIG. 18 is a second schematic diagram of a shape of a pilot resource block according to an embodiment of this application;

FIG. 19 is a third schematic diagram of a shape of a pilot resource block according to an embodiment of this application;

FIG. 20 is a schematic diagram of a structure of a pilot transmission apparatus according to an embodiment of this application;

FIG. 21 is a schematic diagram of a structure of a target communication device according to an embodiment of this application;

FIG. 22 is a schematic diagram of a hardware structure of a network-side device according to an embodiment of this application; and

FIG. 23 is a schematic diagram of a hardware structure of a terminal according to an embodiment of this application.

### DETAILED DESCRIPTION

The following describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communications systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the New Radio (NR) system is described for an illustrative purpose, and NR terms are used in most of the following descriptions. These technologies may also be applied to other systems instead of or in in addition to the NR system, for example, a 6th Generation (6G) communications system.

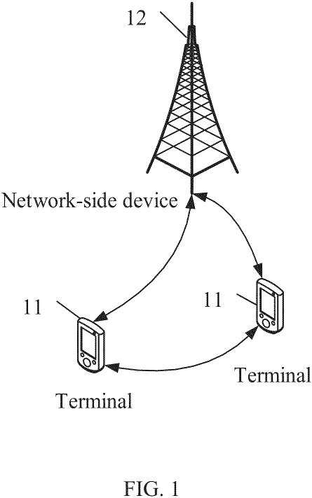

FIG. 1 is a block diagram of a wireless communications system to which an embodiment of this application may be applied. The wireless communications system includes a terminal 11 and a network-side device 12. The terminal 11 may also be referred to as a terminal device or a User Equipment (UE). The terminal 11 may be a terminal-side device such as a mobile phone, a tablet personal computer, a laptop computer or a notebook computer, a Personal Digital Assistant (PDA), a palmtop computer, a netbook, an ultra-mobile personal computer (UMPC), a mobile Internet device (MID), a wearable device, a vehicular device (VUE), or a pedestrian terminal (PUE). The wearable device includes a smart band, an earphone, glasses, or the like. It should be noted that a specific type of the terminal 11 is not limited in the embodiments of this application. The network-side device 12 may be a base station or a core network. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Wireless Local Area Networks (WLAN) access point, a Wi-Fi node, a Transmitting and Receiving Point (TRP), or another appropriate term in the art, as long as the same technical effect is achieved. The base station is not limited to specific technical terms. It should be noted that in the embodiments of this application, only a base station in an NR system is used as an example, but a specific type of the base station is not limited.

For ease of description, the following content is first described:
Downlink control information, DCI;
Physical downlink control channel, PDCCH;
Physical downlink shared channel, PDSCH;
Radio resource control, RRC;
Physical broadcast channel, PBCH;
Master information block, MIB;
System information block, SIB;
Resource element, RE;
Code division multiplexing, CDM;
Orthogonal cover code, OCC;
Mean square error, MSE;
Orthogonal frequency division multiplexing, OFDM;
Bit error rate, BER; and
Block error rate, BLER.

In a complex electromagnetic wave transmission environment in a city, presence of multitudinous scattering, reflecting, and refracting surfaces causes radio signals to arrive at a receive antenna at different moments through different paths, that is, a multipath effect of transmission. Inter symbol interference (ISI) is generated when a previous symbol and a current symbol of a transmit signal arrive simultaneously through different paths, or when a next symbol arrives within a delay spread of a current symbol. Similarly, in frequency domain, due to a Doppler effect caused by a relative speed between a transmit end and a receive end, each subcarrier in which a signal is located has a different frequency offset, resulting in an overlap of subcarriers that might otherwise be orthogonal, that is, inter carrier interference (ICI) is generated. An Orthogonal Frequency Division Multiplexing (OFDM) multi-carrier system used in a communications system is designed with a new cyclic prefix (CP) to have better anti-ISI performance. However, a disadvantage of OFDM is that a size of a subcarrier spacing is limited. Therefore, in a high-speed moving scenario (such as a high-speed railway), a large Doppler frequency shift caused by a high relative speed between the transmit end and the receive end destroys orthogonality between OFDM subcarriers, resulting in severe ICI between subcarriers.

An Orthogonal Time Frequency Space (OTFS) technology is proposed to resolve the foregoing problem in the OFDM system. The OTFS technology defines transform between delay-Doppler domain and time-frequency domain. By simultaneously mapping service data and a pilot to the delay-Doppler domain for processing at the transmit end and the receive end, a delay and a Doppler feature of a channel are captured by designing the pilot in delay-Doppler domain, and a pilot pollution problem caused by ICI in the OFDM system is avoided by designing a guard interval. This makes channel estimation more accurate and helps increase a success rate of data decoding at the receive end.

In the OTFS technology, a guard interval is required around a pilot symbol located in delay-Doppler domain, and a size of the guard interval is related to the channel feature. In this application, the channel is measured, and the size of the guard interval of the pilot symbol is dynamically adjusted based on the channel feature, to ensure approximate minimization of pilot overheads while satisfying the system design and avoid a problem of resource waste caused in a conventional solution that always takes a worst case into account.

The delay and Doppler feature of the channel are essentially determined by a multipath channel. Times of arrival of signals arriving at the receive end through different paths are different due to differences in propagation distances. For example, if two echoes S₁and S₂ travel a distance d₁ and a distance d₂ respectively and arrive at the receive end, a difference between their times of arrival at the receive end is:

$$Δ t = \frac{\left|{d}_{1} - {d}_{2}\right|}{c} ,$$

where c is a speed of light.

Due to the time difference between the echoes S₁ and S₂’ their coherent superposition at the receive end causes an observed signal amplitude jitter, that is, a fading effect. Similarly, a Doppler spread on the multipath channel is also caused by the multipath effect.

The Doppler effect is: due to presence of a relative speed between the transmit end and the receive end, for the signals that arrive at the receive end through different paths, a difference between their angles of incidence relative to a normal line of an antenna causes a difference in relative speeds, and further causes different Doppler frequency shifts of the signals in different paths. Assuming that an original frequency of a signal is f₀, and the relative speed between the transmit end and the receive end is Δv, and an angle of incidence between the signal and the normal line of the antenna at the receive end is θ, the following formula exists:

$$Δ f = \frac{Δ v}{f} cos θ$$

Apparently, when the two echoes S₁ and S₂ arrive at the antenna at the receive end through different paths and have different angles θ₁ and θ₂ of incidence, Doppler frequency shifts Δf₁ and Δf₂ obtained for the two echoes are also different.

In summary, the signal received at the receive end is superposition of component signals with different delays and Doppler shifts from different paths, and is presented on the whole as a received signal with fading and a frequency shift relative to the original signal. Delay-Doppler analysis of the channel helps collect delay-Doppler information of each path, thereby reflecting a delay-Doppler response of the channel.

A full name of an OTFS modulation technology is orthogonal time-frequency space modulation. The technology logically maps information in a data packet with a size of M×N, such as a Quadrature Amplitude Modulation (QAM) symbol, to a M×N grid in two-dimensional delay-Doppler domain, that is, one QAM symbol in the data packet is modulated to a pulse within each grid.

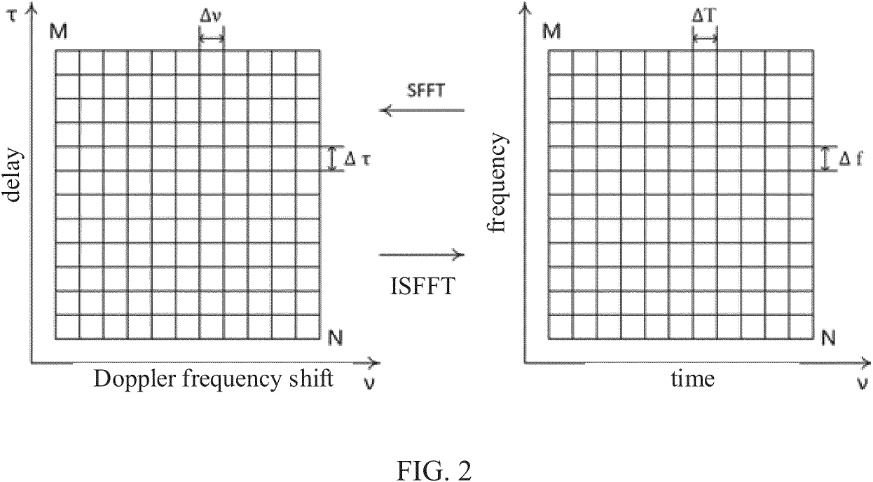

FIG. 2 is a schematic diagram of mutual conversion between the delay-Doppler domain and a time-frequency domain according to an embodiment of this application. As shown in FIG. 2, a data set in an M×N delay-Doppler domain is transformed to an N×M time-frequency domain plane by designing a group of orthogonal two-dimensional basis functions. This transform is mathematically known as Inverse Symplectic Fast Fourier Transform (ISFFT). Correspondingly, transform from the time-frequency domain to the delay-Doppler domain is referred to as Symplectic Fast Fourier Transform (SFFT). A physical meaning behind this is: a delay and Doppler effect of a signal are actually a linear superposition effect of a series of echoes with different time and frequency offsets after the signal passes through a multipath channel. In this sense, delay-Doppler analysis and time-frequency domain analysis can be obtained through mutual conversion between ISFFT and SFFT.

Therefore, the OTFS technology transforms a time-variant multipath channel into a time-invariant two-dimensional delay-Doppler domain channel (for some duration), thereby directly presenting a delay-Doppler response feature of the channel caused by a geometric feature of relative positions of reflectors between a transmitter and a receiver in a radio link. An advantage of this is that OTFS eliminates difficulty in tracking a time-variant fading feature in conventional time-frequency domain analysis and extracts all diversity features of the time-frequency domain channel through delay-Doppler domain analysis instead. In an actual system, a channel impulse response matrix represented by the delay-Doppler domain is sparse because a quantity of delay paths and Doppler frequency shifts of the channel is much smaller than a quantity of time-domain and frequency-domain responses of the channel. Analysis of the sparse channel matrix in delay-Doppler domain by using the OTFS technology can enable encapsulation of a reference signal to be tighter and more flexible, and particularly help support a massive antenna array in a massive MIMO system.

A core of OTFS modulation is that a QAM symbol defined in delay-Doppler domain is transformed to the time-frequency domain for transmission, and then processed in delay-Doppler domain at the receive end. Therefore, a method for analyzing a radio channel response in delay-Doppler domain can be introduced.

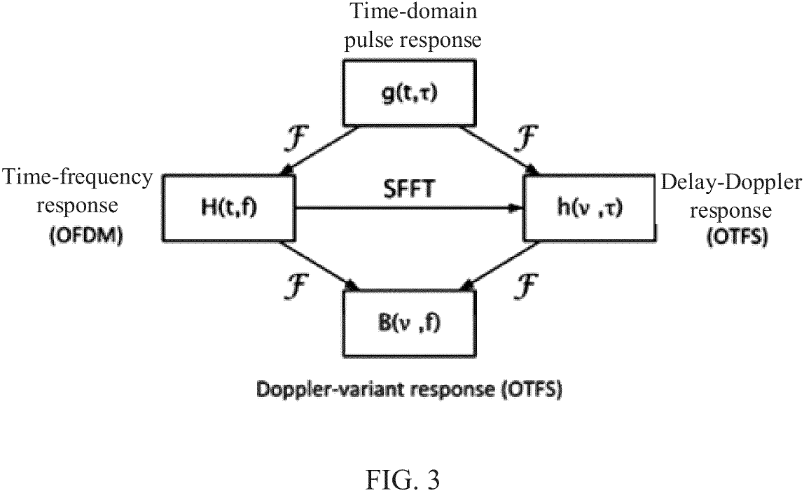

FIG. 3 is a schematic diagram of a channel response relationship in different planes according to an embodiment of this application. FIG. 3 shows a relationship between expressions of a channel response of a signal in different planes when the signal passes through a linear time-variant radio channel.

In FIG. 3, an SFFT transform formula is:

$$h \left(τ , v\right) = ∬ H \left(t , f\right) {e}^{- j 2 π \left(v t - f τ\right)} d τ d v ; \qquad \text{(1)}$$

Correspondingly, an ISFFT transform formula is:

$$H \left(t , f\right) = ∬ h \left(τ , v\right) {e}^{j 2 π \left(v t - f τ\right)} d τ d v ; \qquad \text{(2)}$$

When the signal passes through the linear time-variant channel, assuming that a signal received in time domain is r(t)′ a corresponding signal received in frequency domain is R(f)′ and r(t) = F⁻¹ {R(f)}, r(t) may be expressed in the following form:

$$r \left(t\right) = s \left(t\right) * h \left(t\right) = \int g \left(t , τ\right) s \left(t - τ\right) d τ ; \qquad \text{(3)}$$

From the relationship in FIG. 3, the following can be learned:

$$g \left(t , τ\right) = \int h \left(v , τ\right) {e}^{j 2 π v t} d v ; \qquad \text{(4)}$$

The following can be obtained by substituting (4) into (3):

$$r \left(t\right) = ∬ h \left(v , τ\right) s \left(t - τ\right) {e}^{j 2 π v t} d τ d v ; \qquad \text{(5)}$$

From the relationship shown in FIG. 3, a classical Fourier transform theory, and the formula (5), the following can be learned:

$$\begin{matrix}r \left(t\right) = ∬ h \left(v , τ\right) \left(\int S \left(f\right) {e}^{j 2 π f \left(t - τ\right)} d f\right) {e}^{j 2 π v t} d τ d v \\ = \int \left(∬ h \left(v , τ\right) {e}^{j 2 π \left(v t - f τ\right)} d τ d v\right) S \left(f\right) {e}^{j 2 π f t} d f ; \\ = \int H \left(t , f\right) S \left(f\right) {e}^{j 2 π \text{} f t} d f \\ = {\text{F}}^{- 1} \left\{R \left(f\right)\right\}\end{matrix} \qquad \text{(6)}$$

The equation (6) implies that the analysis of the delay-Doppler domain in the OTFS system can be implemented by relying on an existing communication framework built on time-frequency domain and adding an additional signal processing procedure at the transmit end and the receive end. Moreover, the additional signal processing includes only Fourier transform, and can be implemented by existing hardware without adding a new module. This good compatibility with the existing hardware system greatly facilitates the application of the OTFS system. In an actual system, the OTFS technology can be easily implemented as a pre- and post-processing module of a filtered OFDM system, and therefore has good compatibility with an existing multi-carrier system.

When OTFS is combined with the multi-carrier system, an implementation of the transmit end is as follows: A QAM symbol including to-be-sent information is carried by a waveform in delay-Doppler domain, converted into a waveform in the time-frequency domain plane in the conventional multi-carrier system through two-dimensional Inverse Symplectic Fast Finite Fourier Transform (ISFFT), then changed into time-domain sampling points through symbol-level one-dimensional Inverse Fast Fourier Transform (IFFT) and series-parallel conversion, and sent out.

The process of the receive end of the OTFS system is roughly an inverse process of the transmit end: The time-domain sampling points are received by the receive end, then transformed into a waveform in the time-frequency domain plane through parallel-series conversion and symbol-level one-dimensional Fast Fourier Transform (FFT), and then converted into a waveform in the delay-Doppler domain plane through two-dimensional Symplectic Finite Fourier Transform (SFFT), and then the QAM symbol carried by the waveform in delay-Doppler domain is processed at the receive end, where the processing includes but is not limited to channel estimation and equalization, demodulation and decoding, and the like.

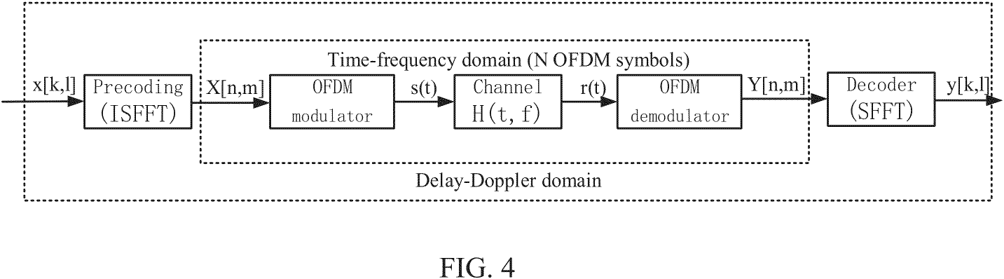

FIG. 4 is a schematic flowchart of processing at a transmit end and a receive end in an OTFS multi-carrier system according to an embodiment of this application.

Advantages of OTFS modulation are mainly presented in the following aspects.

(1) OTFS modulation converts a time-variant fading channel in time-frequency domain between a transmitter and a receiver into a deterministic non-fading channel in delay-Doppler domain. In delay-Doppler domain, each symbol in a group of information symbols sent at a time experiences a same static channel response and SNR.

(2) The OTFS system resolves reflectors on a physical channel by using delay-Doppler images and coherently combines energy from different reflection paths by using a receive equalizer, hence actually providing a non-fading static channel response. By using the foregoing static channel features, the OTFS system does not need to introduce closed-loop channel adaptation to cope with a fast-changing channel as the OFDM system does, thereby improving system robustness and reducing complexity of the system design.

(3) Because a quantity of delay-Doppler states in delay-Doppler domain is much smaller than a quantity of time-frequency states in time-frequency domain, the channel in the OTFS system can be expressed in a very compact form. Channel estimation overheads of the OTFS system are lower and more accurate.

(4) Another advantage of OTFS is presented in copying with an extreme Doppler channel. By analyzing delay-Doppler images with appropriate signal processing parameters, the Doppler feature of the channel is presented completely, thereby facilitating signal analysis and processing in Doppler-sensitive scenarios (for example, high-speed moving and millimeter wave).

Based on the foregoing analysis, a new method can be used for channel estimation in the OTFS system. The transmitter maps a pilot pulse in delay-Doppler domain, and the receive end uses the delay-Doppler image analysis of the pilot to estimate a channel response h(v,τ) in delay-Doppler domain, and then can obtain a channel response expression in time-frequency domain based on the relationship shown in FIG. 3. This facilitates use of a conventional technology in time-frequency domain for signal analysis and processing.

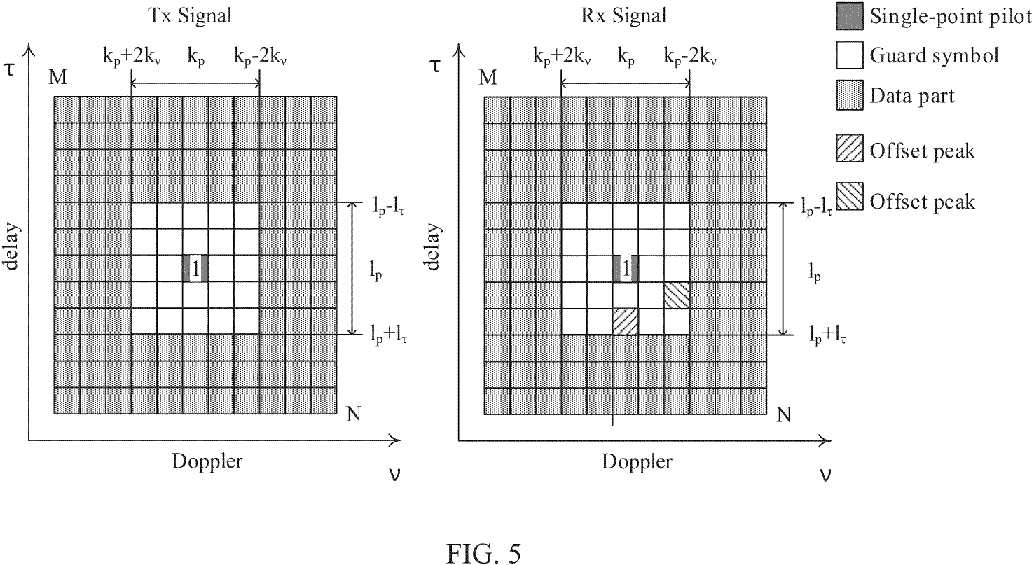

FIG. 5 is a schematic diagram of a pilot mapping in delay-Doppler domain according to an embodiment of this application. FIG. 5 shows a pattern that can be used for the pilot mapping in delay-Doppler domain. A transmit signal in FIG. 5 includes a single-point pilot (a small block numbered 1) located at (lₚ, kₚ), guard symbols (an unshaded part) surrounding the single-point pilot and having an area of (2l_{τ}+1)(4kᵥ+1)-1, and a data part (an area beyond the guard symbols) having an area of MN-(2l_{τ}+1)(4kᵥ+1). At the receive end, there are two offset peaks in a guard band of a delay-Doppler domain grid (a slash shaded part), which means that there are two secondary paths with different delay-Doppler in addition to a primary path of the channel. Amplitudes, delays, and Doppler parameters of all secondary paths are measured to obtain a delay-Doppler domain expression of the channel, that is, _{h(v,τ)}.

In particular, to prevent pollution of a pilot symbol by data on a receive signal grid, which otherwise leads to inaccurate channel estimation, a size of a guard symbol should satisfy the following conditions:

$${l}_{τ} \geq {τ}_{m a x} M Δ f , \text{and} {k}_{v} \geq {v}_{m a x} N Δ T ,$$

where τₘₐₓ and vₘₐₓ are a maximum delay and a maximum Doppler frequency shift for all paths of the channel respectively.

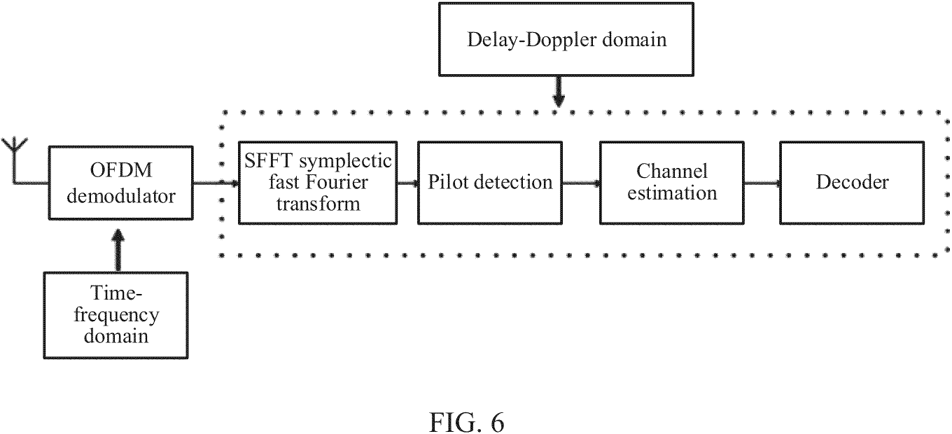

FIG. 6 is a schematic diagram of pilot position detection at a receive end according to an embodiment of this application. As shown in FIG. 6, a main process of the pilot position detection is: OFDM demodulator → SFFT symplectic Fourier transform → pilot detection → channel estimation → decoder. The receive end converts received time-domain sampling points into QAM symbols in delay-Doppler domain through an OFDM demodulator and OTFS transform (SFFT in the figure) process, and then uses threshold-based signal power detection to determine a location of a pilot pulse. It should be noted that because power boost is usually performed for transmission of the pilot, power of the pilot pulse at the receive end is much higher than data power, and because the pilot pulse and data symbols undergo exactly the same fading, the location of the pilot can be easily determined by using power detection.

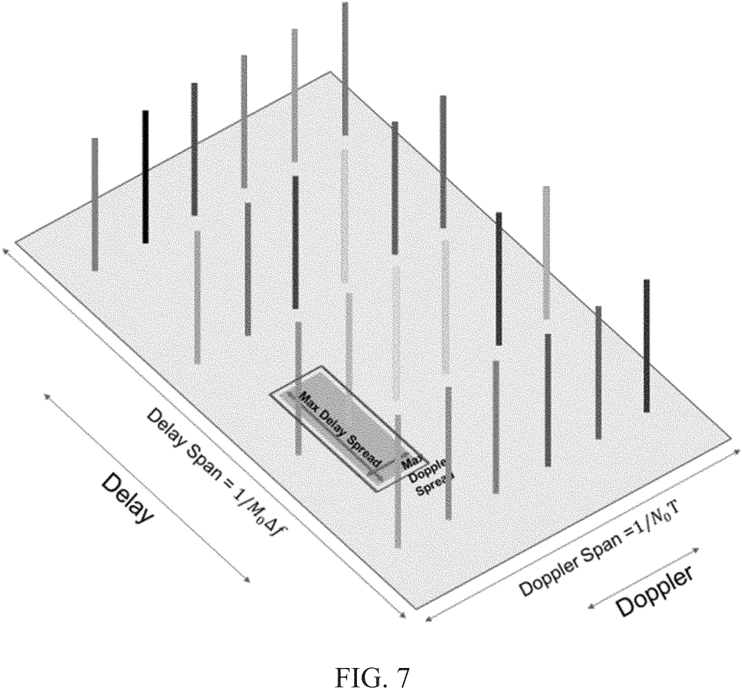

A method provided in FIG. 5 corresponds to a single-port scenario, where only one group of reference signals needs to be transmitted. In a modern multi-antenna system, a plurality of antenna ports are often used to transmit a plurality of streams of data simultaneously, thereby making full use of spatial freedom of the antennas to achieve a purpose of obtaining a spatial diversity gain or enhancing a system throughput. FIG. 7 is a schematic diagram of mappings of multi-port reference signals in delay-Doppler domain according to an embodiment of this application. When a plurality of antenna ports exist, a plurality of pilots need to be mapped in delay-Doppler domain, leading to a pilot mapping pattern in FIG. 7.

In FIGS. 7, 24 antenna ports correspond to 24 pilot signals. Each pilot signal uses the form in FIG. 5, that is, a pattern with an impulse signal at a center point and guard symbols on both sides. A quantity of delay-Doppler domain REs (resource elements) occupied by a single pilot is (2l_{τ}+1)(4kᵥ+1). If there are P antenna ports, considering that guard bands of adjacent antenna ports can be reused, assuming that the pilot is placed by using a delay dimension P₁ and a Doppler dimension _{P2} that satisfy _{P} _{=P1P2}, total resource overheads of the pilot are [P₁(1_{τ}+1)+l_{τ}][P₂(2kᵥ+1)+2kᵥ].

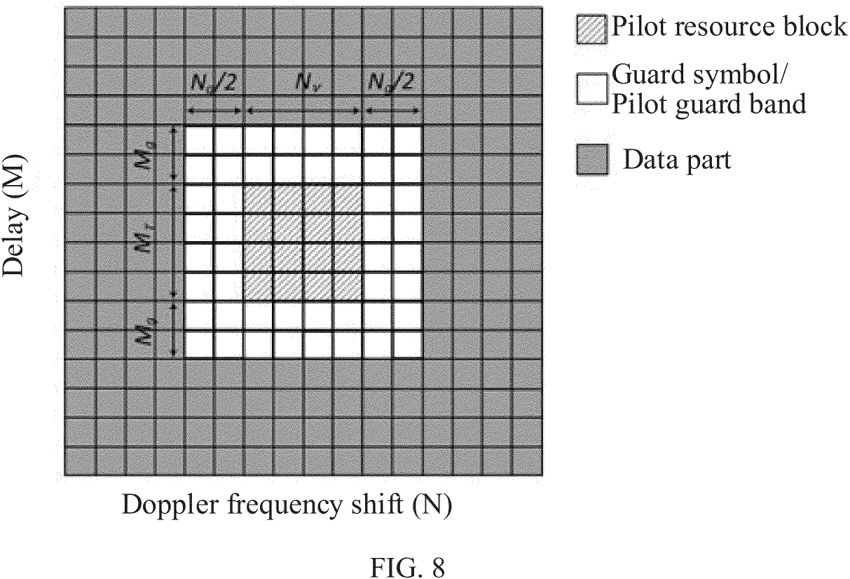

FIG. 8 is a schematic diagram of pilot resource reuse in delay-Doppler domain according to an embodiment of this application. As can be learned, advantages in single-port transmission are that few resources are occupied and that a detection algorithm is simple. However, for a communications system with a plurality of antenna ports, the scheme with a single-point pilot and guard bands does not allow resource reuse and therefore causes a linear increase of overheads. Therefore, for a multi-antenna system, a pilot mapping scheme shown in FIG. 8 is proposed.

In FIG. 8, a pilot is not in a form of a single-point pulse; instead, a pilot sequence is constructed based on a PN sequence generated in a specific way and is mapped to a two-dimensional resource grid in delay-Doppler domain according to a specific rule, that is, a slash shaded part in the figure. In this application, a resource position occupied by the pilot sequence, that is, the slash shaded part, may be referred to as a pilot resource block. An unshaded area next to the pilot resource block is a pilot guard band, including blank resource elements that do not transmit any signal/data. Similar to the foregoing single-point pilot, the pilot resource block is also surrounded by a guard band to avoid mutual interference with data. A width of the guard band is calculated in the same way as in the single-point pilot mapping pattern in FIG. 5. A difference is: a resource part to which the pilot sequence is mapped is different from that in the single-point pilot mapping pattern. Pilot signals of different ports can be generated by selecting low-correlation sequences, and overlap-mapped to a same resource block. Then the pilot sequence is detected by using a specific algorithm at the receive end, to distinguish pilots corresponding to different antenna ports. Due to complete resource reuse at the transmit end, pilot overheads in the multi-antenna port system can be greatly reduced.

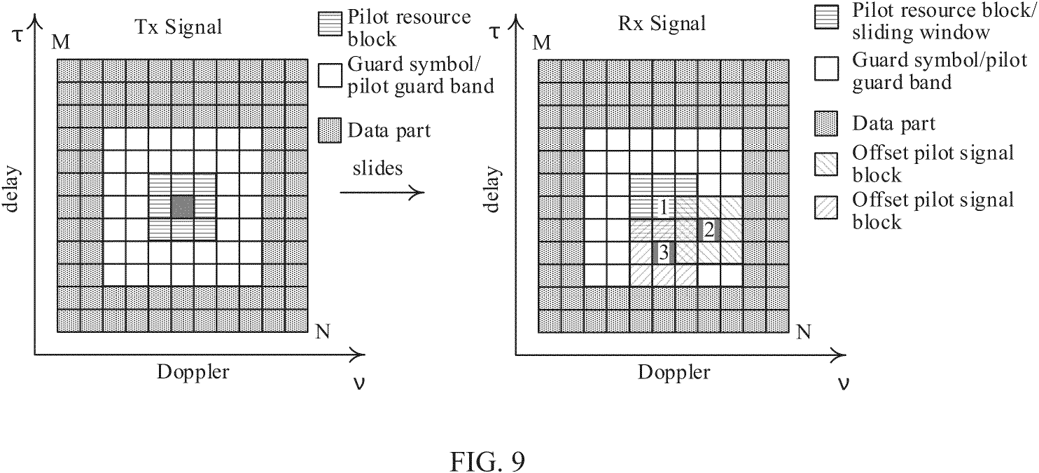

FIG. 9 is a schematic diagram of pilot sequence detection according to an embodiment of this application. FIG. 9 presents a detection mode based on a pilot sequence. Similar to the foregoing scenario in FIG. 5, at the receive end, due to different delays and Doppler frequency shifts of two paths of the channel, the received pilot signal block is shifted in delay-Doppler domain to positions of blocks in the slash shaded part in the figure on the whole (that is, a block numbered 2 and eight blocks adjacent to the block, and a block numbered 3 and eight blocks adjacent to the block). In this case, a sliding window detection operation is performed in delay-Doppler domain at the receive end by using known transmit pilots (a horizontal line shaded part in the figure, that is, the block numbered 1 and the eight blocks adjacent to the block). It is known that when a sliding window detection operation result M(R,S)[δ,ω] is within N_{P}→+∞, the result has the following property (a probability that the following formula is true approaches 1):

$$\begin{matrix}M \left(R , S\right) \left[δ , ω\right] = 1 + {{ε}^{′}}_{{N}_{P}} , i f \left(δ , ω\right) = \left({δ}_{0} , {ω}_{0}\right) ; \\ = {ε}_{{N}_{P}} , i f \left(δ , ω\right) \neq \left({δ}_{0} , {ω}_{0}\right)\end{matrix} \qquad \text{(7)}$$

where

$$\left|ε {′}_{{N}_{P}}\right| \leq \frac{1}{\sqrt{{N}_{P}}} ,$$

$$\left|{ε}_{{N}_{P}}\right| \leq \frac{C + 1}{\sqrt{{N}_{P}}} ,$$

and C>) is a constant

In the formula, (δ,ω) and (δ₀,ω₀) are respectively a position at which a sliding window (center point) is currently located and a position to which a pilot signal block (center point) in a received signal is shifted. As can be learned from the formula, a value near 1 can be obtained only when (δ,ω)=(δ₀,ω₀), or conversely, the sliding window detection operation result is a small value. Therefore, when the sliding window (the horizontal line shaded part in the figure, that is, the block numbered 1 and the eight blocks adjacent to the block) coincides with the shifted pilot signal block (the slash shaded part in the figure, that is, the block numbered 2 and the eight blocks adjacent to the block, and the block numbered 3 and the eight blocks adjacent to the block), a detector calculates an energy peak presented at a position (δ₀,ω₀) in delay-Doppler domain, that is, the positions of the small blocks numbered 2 and 3 in the figure. Using this method, the receive end can obtain a correct pilot position based on a value of M(R, S), that is, obtain the delay and Doppler information of the channel, provided that a sufficient length of N_{P} is ensured. In addition, an amplitude value of the channel is given by the value 1+ε′_{NP} obtained from the detection operation.

The scheme in FIG. 8 (referred to as the pilot sequence) has advantages and disadvantages in comparison with the scheme in FIG. 7 (referred to as the pilot pulse). Advantages of the pilot sequence scheme are:
(1) multi-port/multi-user multiplexing is facilitated;
(2) accuracy of sequence detection can be flexibly adjusted;
(3) guard symbol overheads are reduced; and
(4) even if the overheads are insufficient (to be specific, a reserved width of the guard band of the pilot is less than a width that is calculated based on the maximum channel delay and maximum Doppler shifts and that makes the data and the pilot at the receive end free of mutual interference), channel estimation accuracy can be maintained to ensure that a performance loss of the system is within an acceptable range.

Disadvantages are:
(1) complexity of sequence correlation or matching detection is high; and
(2) accuracy is constrained by the sequence length, and when the sequence length is long, overheads of the pilot and pilot guard band are high.

Advantages of the pilot pulse scheme are:
(1) the receive end only needs to use power detection and the algorithm is simple; and
(2) a detection success rate can be increased by power boost (power boost, that is, the transmitter alone increases transmit power of the pilot signal).

A disadvantage is:

each pilot pulse needs to be provided with a separate guard band, resulting in high overheads during multi-port transmission.

The foregoing advantages and disadvantages can summarize the performance of the two schemes in each scenario.

In addition, in some scenarios, overheads of the pilot guard interval are limited and are not sufficient to fully cover possible delays and Doppler shifts of the channel. In this case, the pilot sequence scheme still exhibits acceptable performance, but the pilot pulse scheme has a very large performance loss.

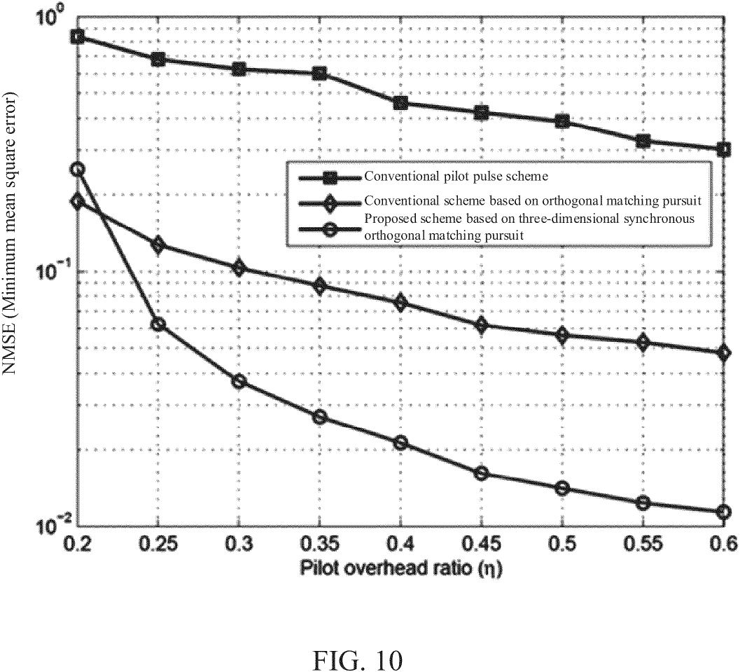

FIG. 10 is a schematic diagram of performance comparison of two pilot design schemes under different pilot overhead conditions according to an embodiment of this application. As shown in FIG. 10, broken lines with diamonds and circles in the figure are performance curves of the pilot sequence scheme based on different detection algorithms, while broken lines with squares are performance curves of the pilot pulse scheme. It can be learned that in a particular scenario (a large delay and Doppler shift of the channel) shown in the figure, even if pilot overheads reach 60%, the performance of the pilot pulse scheme is still much worse than the performance of the pilot sequence scheme.

Given multiple antenna ports, the existing sequence-based pilot design scheme shows significant advantages, but still has the following disadvantages:
(1) Because of simply using PN sequences (Pseudo-Noise Code) superposed at a same resource position, when a quantity of superposed layers is large, there is a risk of a high probability of wrong detection due to a low signal-to-noise ratio (SNR) of a received signal;
(2) different PN sequences are just simply used to indicate different ports; if additional information can be added in generation of a sequence and other useful information is indicated by reusing the sequence, the purpose of reducing pilot overheads can also be achieved, and system performance is further improved; and
(3) because the sequence-based pilot design is more complex than the pilot pulse, new design requirements are raised for uplink and downlink indication messages, feedback messages, and interaction processes, but the prior art lacks designs and descriptions in this aspect.

To overcome all or some of the foregoing disadvantages, this application provides a pilot transmission method and apparatus. The pilot transmission method provided in embodiments of this application is hereinafter described in detail by using specific embodiments and application scenarios thereof with reference to the accompanying drawings.

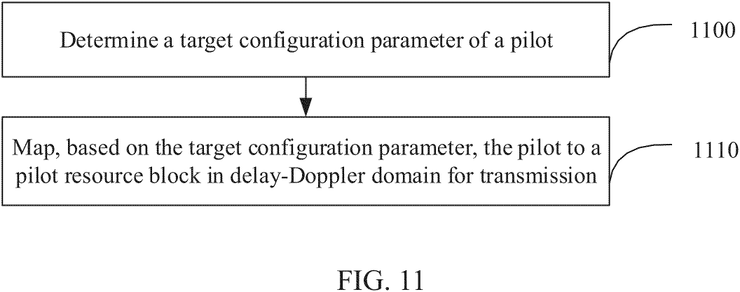

FIG. 11 is a schematic flowchart of a pilot transmission method according to an embodiment of this application. The pilot transmission method is applied to a target communication device. As shown in FIG. 11, the pilot transmission method includes the following steps.

Step 1100: Determine a target configuration parameter of a pilot.

Step 1110: Map, based on the target configuration parameter, the pilot to a pilot resource block in delay-Doppler domain for transmission.

In some embodiments, to overcome a disadvantage that excessive pilot overheads or low pilot reliability is caused by lack of attention to a pilot parameter configuration in the prior art, the pilot may be configured and then mapped to the pilot resource block in delay-Doppler domain for transmission.

In some embodiments, a suitable target configuration parameter such as a length of the pilot or transmit power of the pilot may be determined first, and when the pilot is overlap-mapped to the pilot resource block, a target overlap-mapped pilot quantity may be further determined; and the pilot is configured based on at least one of the parameters, and the pilot is generated and mapped to the pilot resource block in delay-Doppler domain for transmission to minimize pilot overheads while reliability of pilot detection is ensured.

In some embodiments, the pilot may be generated by using a common sequence.

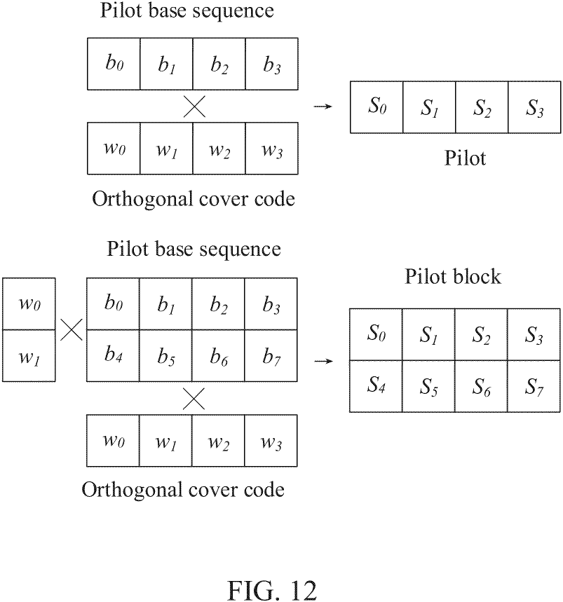

In some embodiments, to reduce a probability of false detection and wrong detection of the pilot, a pilot base sequence may be orthogonalized before the pilot is generated, and after a pilot corresponding to an antenna port is determined, the pilot is mapped to a corresponding pilot resource block. FIG. 12 is a schematic diagram of a relationship between a pilot base sequence, an orthogonal cover code, and a pilot according to an embodiment of this application. As shown in FIG. 12, the pilot may be obtained by orthogonalizing the pilot base sequence by using the orthogonal cover code.

In some embodiments, a general method for constructing a pilot (or reference signal) in delay-Doppler domain is as follows:

First, a pilot base sequence is generated.

In some embodiments, the pilot base sequence includes a PN sequence or a ZC (Zadoff-chu’) sequence.

In some embodiments, the pilot base sequence may include but is not limited to a PN sequence, a ZC sequence, or other similar sequences.

The PN sequence may include the following sequence: an M sequence, a Gold sequence, a Kasami sequence, a Barker sequence, or the like.

Then the pilot may be obtained by modulating the pilot base sequence to obtain a pilot sequence.

In some embodiments, an Orthogonal Complementary Code (OCC) may be used to further enhance orthogonality to obtain the pilot.

In some embodiments, after the pilot is generated, the pilot may be inserted at a transmit end.

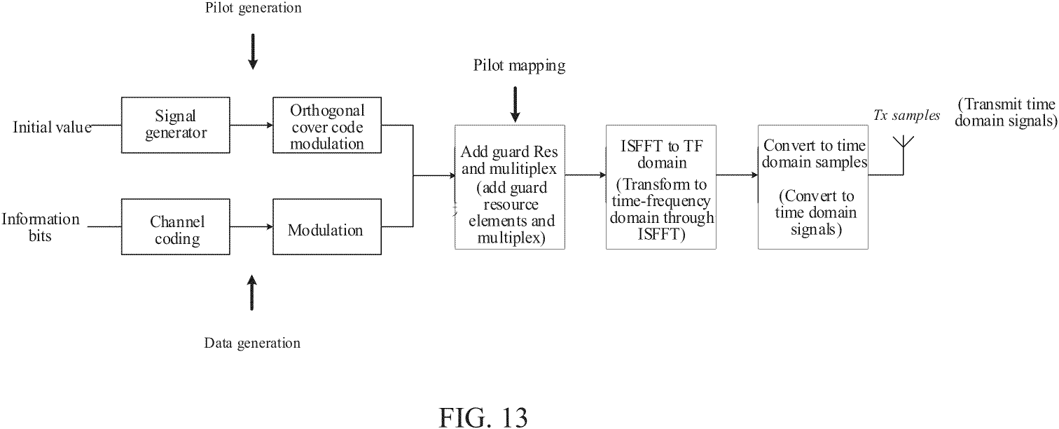

FIG. 13 is a schematic flowchart for inserting a pilot in delay-Doppler domain according to an embodiment of this application. As shown in FIG. 13, a general processing procedure for inserting the pilot at the transmit end is as follows: Information bits of data are encoded and modulated to generate a modulation symbol in delay-Doppler domain. A pilot and a data symbol are mapped to a grid in delay-Doppler domain (similar to an OFDM grid in time-frequency domain), where each grid cell is referred to as a Resource Element (RE) in delay-Doppler domain. REs of the pilot and data are orthogonal, and a guard interval is added between them to avoid mutual interference at a receive end A pilot sequence and data are modulated separately and then placed in a same pilot resource block in delay-Doppler domain. The pilot and data occupy orthogonal resources and are separated by a guard band. The entire resource block in delay-Doppler domain containing the pilot and data is transformed into time-frequency domain through ISFFT and subsequently converted through OFDM-like processing into a time-domain signal for transmission.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

In some embodiments, in a case that a communication peer of the target communication device is a terminal or a network-side device, the target configuration parameter of the pilot includes:

a target length of the pilot and target transmit power of the pilot.

In some embodiments, in an actual system, detection performance of the pilot signal is closely related to the pilot. From the formula (7), it can be learned that the longer the pilot is, the more accurate the detection of the pilot signal is. In addition, the larger the SINR of the pilot signal is, the more accurate the detection of the pilot signal is.

Therefore, to improve detection accuracy of the pilot signal, increasing the length of the pilot and increasing the transmit power of the pilot are both feasible approaches.

However, because the pilot cannot transmit a large amount of information and is essentially an overhead, increasing the length of the pilot and increasing the transmit power of the pilot further increase resource overheads and energy overheads of the pilot respectively. Therefore, a balance between reliability and overheads of the pilot detection can be pursued to determine a more appropriate target length of the pilot and target transmit power of the pilot.

In some embodiments, with regard to the resource overheads of the pilot, increasing a length of the pilot sequence not only increases overheads of the pilot signal itself, but also increases overheads of the guard band of the pilot and increases resource occupation. In addition, given a total quantity of delay-Doppler resource blocks, increasing resources used for the pilot and its guard band inevitably reduces resources used for data. As a result, when the same information bits are transmitted, a coding rate or a modulation order of a data part is forced to increase, and reliability of data decoding may be affected.

Therefore, for different channel states, different pilot sequence lengths and pilot transmit power can be used, so that the performance is optimal

In some embodiments, the target length of the pilot and the target transmit power of the pilot may be determined when the target configuration parameter of the pilot is determined.

In some embodiments, in a case that a communication peer of the target communication device is a terminal or a network-side device, for example, when the network side transmits information to the terminal, or when the terminal transmits information to the network side, or when the terminal transmits information to a terminal, the target length of the pilot and the target transmit power of the pilot may be determined for configuring the pilot.

In some embodiments, after the pilot is configured based on the target length of the pilot and the target transmit power of the pilot, when the pilot is mapped to the pilot resource block in delay-Doppler domain, the mapping may be a single-point mapping, that is, each pilot is in a one-to-one correspondence with a pilot resource block, and a plurality of pilots do not overlap each other.

In some embodiments, in a case that a communication peer of the target communication device is a terminal, the target configuration parameter of the pilot includes: a target length of the pilot and a target overlap-mapped pilot quantity.

In some embodiments, pilots corresponding to different antenna ports may be overlap-placed, that is, the pilots may be overlap-mapped to one or more pilot resource blocks.

Because the pilots are overlap-placed, simply using the method of increasing the transmit power of the pilot signal cannot effectively increase a channel estimation or detection success rate. A reason is as follows:

A signal-to-noise ratio may be defined as

$$\text{SNR} = 10 log \left(\frac{p}{{σ}^{2}}\right)$$

and is a constant. It is assumed that k pilots are overlap-placed and that power of each pilot is p. When a pilot is processed, the other pilots may be considered as interference, and a received signal-to-noise ratio of the pilot is:

$${\text{SINR}}_{\text{p}} = 10 log \left(\frac{p}{\left(k - 1\right) p + {σ}^{2}}\right) .$$

When a power boost is mp, the received signal-to-noise ratio of the pilot is:

$${\text{SINR}}_{\text{mp}} = 10 log \left(\frac{m p}{\left(k - 1\right) m p + {σ}^{2}}\right) .$$

A signal-to-noise ratio boost at the receive end is:

$${\text{SINR}}_{\text{mp}} - {\text{SINR}}_{\text{p}} = 10 log \left(\frac{\left(k - 1\right) m p + m {σ}^{2}}{\left(k - 1\right) m p + {σ}^{2}}\right) ;$$

$${\text{lim}}_{m \to ∞} \left({\text{SINR}}_{\text{mp}} - {\text{SINR}}_{\text{p}}\right) = 10 log \left(1 + \frac{{σ}^{2}}{\left(k - 1\right) p}\right) ;$$

It can be learned that when the SNR is large (that is,

$$\frac{{σ}^{2}}{p}$$

is small), a marginal effect of a gain resulting from boosting the transmit power of the pilot decreases severely with the increase of m.

Therefore, performance of pilot detection of a receiver can be improved by adjusting a quantity of overlapped pilots, that is, a value of k in the SINR expression.

In some embodiments, when the target configuration parameter of the pilot is determined, the target length of the pilot and the target overlap-mapped pilot quantity may be determined for configuring the pilot.

In some embodiments, in a case that a communication peer of the target communication device is a terminal, for example, when the network side transmits information to the terminal, or when the terminal transmits information to a terminal, the target length of the pilot and the target overlap-mapped pilot quantity may be determined for configuring the pilot.

In some embodiments, after the pilot is configured based on the target length of the pilot and the target overlap-mapped pilot quantity, when the pilot is mapped to the pilot resource block in delay-Doppler domain, the mapping may be an overlap mapping, that is, pilots corresponding to one or more antenna ports are mapped to a plurality of pilot resource blocks, where a pilot corresponding to one antenna port is mapped to only one pilot resource block for transmission, and pilots corresponding to one or more different antenna ports may be mapped to one pilot resource block.

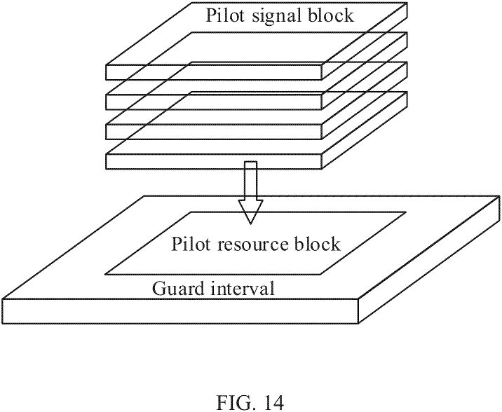

FIG. 14 is a schematic diagram of pilot signal blocks overlap-mapped to a pilot resource block according to an embodiment of this application. As shown in FIG. 14, pilot sequences corresponding to a plurality of antenna ports may be mapped to one or more pilot resource blocks. Therefore, one or more pilot resource blocks can be determined in delay-Doppler domain, and then pilots corresponding to the plurality of antenna ports are mapped to the pilot resource blocks for transmission.

In some embodiments, when a plurality of pilots are mapped to a plurality of pilot resource blocks, the mapping pattern may be determined according to a rule. The rule may be specified in a protocol or preset in a system, and may be adjusted flexibly based on a channel state change.

In some embodiments, the pilot may selectively carry some information (for example, time information and UE ID information) when generated, to achieve a purpose of using the pilot to transmit information to reduce the overheads.

In some embodiments, the method further includes:
determining, based on received first feedback information, that adjusting the target configuration parameter of the pilot is required, where
the first feedback information is obtained after a communication peer decodes a data packet and obtains decoding related information.

In some embodiments, to achieve a balance between reliability and overheads of pilot detection, the target configuration parameter of the pilot may be adjusted to determine an optimal or better target configuration parameter.

In some embodiments, it may be determined, based on some related information, such as the first feedback information transmitted by the communication peer after decoding the data packet, that adjusting the target configuration parameter of the pilot is required.

For different channel states, different target configuration parameters may be used to optimize the performance. A reason for this is that the configuration parameter of the pilot, such as the length of the pilot and the power of the pilot, may directly affect channel estimation accuracy. A direct measurement criterion is an MSE between an estimated channel Hₑₛₜ and a real channel H, and (l,s) = argmin_{(l,s)} E[(H -Hₑₛₜ(l,s))(H - Hₑₛₜ(l,s))^{H}] may be determined, where l is the length of the pilot, and s is the SINR of the received signal.

In some embodiments, the decoding related information may be a BER or may be similar information in a decoding result.

Actually, because a real channel condition is not known, a parameter that can be observed by using a receiver, such as the BER of the decoding result, can be used to indirectly assess accuracy of channel estimation.

In a specific implementation, a metric used to determine suitability of the pilot parameter may be the BER, that is, the decoding related information may be the BER. In a case that other conditions remain unchanged, a BER of decoded data of the receiver depends on accuracy of channel estimation and may be directly determined by the configuration parameter of the pilot, for example, may be determined by the length of the pilot and the power of the pilot, and may be denoted as bler(l,s).

In some embodiments, given that a target BER of a current service is ε, only the smallest l and s that satisfy ber(l,s) ≤ ε need to be selected as the target configuration parameter to reduce the overheads maximally.

In some embodiments, in a case that other conditions are determined, the BER of the decoded data of the receiver depends on accuracy of channel estimation and may be determined by the length of the pilot and an overlap-mapped pilot quantity, and may be denoted as bler(l,k), where l is the length of the pilot, and k is the quantity of pilots.

In some embodiments, given that the target BER of the current service is ε, only the smallest l and the largest k that satisfy ber(l, s) ≤ ε need to be selected as the target configuration parameter to reduce the overheads maximally.

In some embodiments, the first feedback information includes: the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

In some embodiments, because the first feedback information is obtained by the communication peer after the communication peer decodes the data packet and obtains the decoding related information, the first feedback information may be directly the decoding related information, that is, the communication peer of the target communication device may directly transmit the decoding related information to the target communication device, so that the target communication device determines, based on the decoding related information, whether the target configuration parameter of the pilot needs to be adjusted.

In some embodiments, because the first feedback information is obtained by the communication peer after the communication peer decodes the data packet and obtains the decoding related information, the first feedback information may be the indication information for adjusting the target configuration parameter, transmitted by the communication peer to the target communication device after the communication peer determines, based on the decoding related information, that adjusting the target configuration parameter of the pilot is required, where the indication information for adjusting the target configuration parameter is used to instruct the target communication device to adjust the target configuration parameter, so that the target communication device determines, after receiving the indication information for adjusting the target configuration parameter, that adjusting the target configuration parameter of the pilot is required.

In some embodiments, the decoding related information may be a BER or may be similar information in a decoding result.

In some embodiments, the determining, based on the decoding related information, that the target configuration parameter needs to be adjusted includes:

in a case that the decoding related information is greater than a first preset threshold, determining that the target configuration parameter needs to be adjusted.

A target value of the decoding related information, that is, the first preset threshold, may be preset in the system or specified in a protocol. In a case of determining and finding that the decoding related information is greater than the first preset threshold, it may be determined that the target configuration parameter needs to be adjusted.

In some embodiments, the decoding related information may be determined by the length of the pilot and the power of the pilot. For example, the decoding related information is a BER and may be denoted as bler(l,s).

In some embodiments, the target BER of the current service may be preset to ε, that is, the first preset threshold. In this case, only the smallest l and s that satisfy ber(l,s) ≤ ε need to be selected as the target configuration parameter to reduce the overheads maximally, so that the target configuration parameter can be adjusted in a case of determining and finding ber(l, s) > ε.

In some embodiments, the decoding related information may be determined by the length of the pilot and the overlap-mapped pilot quantity. For example, the decoding related information is a BER and may be denoted as bler(l,k).

In some embodiments, in a case that other conditions are determined, the BER of the decoded data of the receiver further depends on accuracy of channel estimation and may be determined by the length of the pilot and the overlap-mapped pilot quantity, and may be denoted as bler(l,k), where l is the length of the pilot, and k is the quantity of pilots.

In some embodiments, the target BER of the current service may be preset to ε, that is, the first preset threshold. In this case, only the smallest l and the largest k that satisfy ber(l, k) ≤ ε need to be selected as the target configuration parameter to reduce the overheads maximally, so that the target configuration parameter can be adjusted in a case of determining and finding ber(l, k) > ε.

In some embodiments, the adjusting the target configuration parameter of the pilot includes:
adjusting the target configuration parameter of the pilot based on a target configuration parameter table, where
the target configuration parameter table is specified in a protocol in advance.

In some embodiments, a rule for selecting the target configuration parameter in delay-Doppler domain in this embodiment may be determined.

In some embodiments, a protocol may specify a target configuration parameter table known to a transmit end and a receive end, specifying all possible combinations of target configuration parameters; afterward, the target communication device may select and adjust the target configuration parameter of the pilot based on the target configuration parameter table.

In some embodiments, the adjusting the target configuration parameter of the pilot includes:
adjusting the target configuration parameter of the pilot based on a preset adjustment value, where
the preset adjustment value is specified in a protocol in advance.

In some embodiments, a protocol may specify a preset adjustment value known to a transmit end and a receive end, specifying an increment or a decrement for each adjustment of the target configuration parameter; for example, a power boost value of the pilot is a power increment of a pilot signal relative to a data signal.

In some embodiments, the target communication device may select and adjust the target configuration parameter of the pilot based on the preset adjustment value.

In some embodiments, in a case that a communication peer of the target communication device is a terminal or a network-side device, the adjusting the target configuration parameter of the pilot includes: increasing target transmit power of the pilot based on the target configuration parameter table and a target length of the pilot.

In some embodiments, in a case that the mapping of the pilot to the pilot resource block in delay-Doppler domain is a single-point mapping, the target configuration parameter table may be a pilot length and power indication table, as shown in the following Table 1:

TABLE 1

Pilot length and power indication

| Index | Pilot length | Pilot transmit power |
|---|---|---|
| 1 | l₁ | p₁ |
| | | p₂ |
| 2 | l₂ | p₁ |
| | | p₂ |
| | | ... |
| 3 | l₃ | p₁ |
| | | p₂ |
| | | ⋯ |
| 4 | ... | ⋯ |

It should be noted that Table 1 is used only as an example of the target configuration parameter tablse and does not serve as a limitation on the target configuration parameter table.

In some embodiments, all target transmit power corresponding to a current target length of the pilot may be found in the target configuration parameter table based on the current target length of the pilot, and target transmit power higher than current target transmit power is determined.

For example, the current target length of the pilot is l₁, and the transmit power corresponding to the current target length of the pilot in the pilot length and power indication table includes: p₁, p₂, p₃, ..., where p₁ < p₂ < p₃<.... If the current target length of the pilot is l₁,and the current target transmit power is p₁, and it is determined that the target configuration parameter needs to be adjusted, the target transmit power may be adjusted to p₂, or in some embodiments, may be adjusted to p₃.

In some embodiments, when the target transmit power of the pilot is adjusted and increased based on the target configuration parameter table and the target length of the pilot, the target transmit power may be increased sequentially in ascending order of transmit power in the target configuration parameter table, or any target transmit power higher than the current target transmit power may be selected, or the target transmit power may be increased in ascending order of transmit power in the target configuration parameter table based on a rule with one or more as an interval. This is not limited in this embodiment.

In some embodiments, in a case that a communication peer of the target communication device is a terminal or a network-side device, the adjusting the target configuration parameter of the pilot includes:

increasing target transmit power of the pilot based on the preset adjustment value and a target length of the pilot.

In some embodiments, in a case that the mapping of the pilot to the pilot resource block in delay-Doppler domain is a single-point mapping, the current target transmit power may be adjusted based on the current target length of the pilot and the preset adjustment value.

For example, the current target length of the pilot is l₁, the current target transmit power is p₁, and the preset adjustment value is a, where a is a positive number; and if it is determined that the target configuration parameter needs to be adjusted, the target transmit power may be adjusted to p₁ + n × a, where n≥1.

In some embodiments, the method further includes: if determining, based on received second feedback information, that adjusting the target configuration parameter of the pilot is required, and determining that the target transmit power of the pilot is less than a second preset threshold, continuing to adjust the target configuration parameter of the pilot, where the second preset threshold includes a preset value, or highest transmit power corresponding to the target length of the pilot in the target configuration parameter table,

In some embodiments, in a case of a single-point mapping of the pilot, after the target configuration parameter of the pilot is adjusted, the target configuration parameter may be transmitted together with data to the communication peer; and the communication peer may obtain the decoding related information after performing decoding, and transmit the second feedback information to the target communication device based on the decoding related information.

It may be understood that the first feedback information and the second feedback information, and the manners of obtaining the first feedback information and the second feedback information are similar.

In some embodiments, the second feedback information includes:

the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

In some embodiments, because the second feedback information is obtained by the communication peer after the communication peer decodes the data packet and obtains the decoding related information, the second feedback information may be directly the decoding related information, that is, the communication peer of the target communication device may directly transmit the decoding related information to the target communication device, so that the target communication device determines, based on the decoding related information, whether the target configuration parameter of the pilot needs to be adjusted.

In some embodiments, because the second feedback information is obtained by the communication peer after the communication peer decodes the data packet and obtains the decoding related information, the second feedback information may be the indication information for adjusting the target configuration parameter, transmitted by the communication peer to the target communication device after the communication peer determines, based on the decoding related information, that adjusting the target configuration parameter of the pilot is required, where the indication information for adjusting the target configuration parameter is used to instruct the target communication device to adjust the target configuration parameter, so that the target communication device determines, after receiving the indication information for adjusting the target configuration parameter, that adjusting the target configuration parameter of the pilot is required.

In some embodiments, the decoding related information may be a BER or may be similar information in a decoding result.

In some embodiments, the determining, based on received second feedback information, that adjusting the target configuration parameter of the pilot is required includes:
determining, based on the decoding related information, that the target configuration parameter needs to be adjusted; or
determining, based on the indication information for adjusting the target configuration parameter, that the target configuration parameter needs to be adjusted.

In some embodiments, the determining, based on the decoding related information, that the target configuration parameter needs to be adjusted includes: in a case that the decoding related information is greater than a first preset threshold, determining that the target configuration parameter needs to be adjusted.

A target value of the decoding related information, that is, the first preset threshold, may be preset in the system or specified in a protocol. In a case of determining and finding that the decoding related information is greater than the first preset threshold, it may be determined that the target configuration parameter needs to be adjusted

In some embodiments, the decoding related information may be determined by the length of the pilot and the power of the pilot. For example, the decoding related information is a BER and may be denoted as bler(l,s).

In some embodiments, the target BER of the current service may be preset to ε, that is, the first preset threshold. In this case, only the smallest l and s that satisfy ber(l, s) ≤ ε need to be selected as the target configuration parameter to reduce the overheads maximally, so that the target configuration parameter can be adjusted in a case of determining and finding ber(l, s) > ε.

In some embodiments, after it is determined, based on the received second feedback information, that adjusting the target configuration parameter of the pilot is required, it is possible to further determine whether the target transmit power of the pilot is less than the second preset threshold, and continue to adjust the target configuration parameter of the pilot if the target transmit power of the pilot is less than the second preset threshold, for example, continue to increase the target transmit power of the pilot.

In some embodiments, the method further includes:

if determining, based on received second feedback information, that adjusting the target configuration parameter of the pilot is required, and determining that the target transmit power of the pilot is greater than or equal to a second preset threshold, increasing the target length of the pilot.

In some embodiments, the second preset threshold of the target transmit power of the pilot corresponds to the target length of the pilot, and each length of the pilot may correspond to a different or same second preset threshold of the target transmit power.

In some embodiments, if the target transmit power of the pilot is greater than or equal to the second preset threshold in a case that the target length of the pilot remains unchanged, it may be considered that transmission performance is already optimal at the current target length of the pilot, and if transmission performance better than current transmission performance is required, the target length of the pilot may be adjusted, for example, the target length of the pilot is increased.

In some embodiments, after it is determined, based on the received second feedback information, that adjusting the target configuration parameter of the pilot is required, it is possible to further determine whether the target transmit power of the pilot is less than the second preset threshold; and if the target transmit power of the pilot is greater than or equal to the second preset threshold, it may be considered that transmission performance is already optimal at the current target length of the pilot. However, because the target configuration parameter of the pilot still needs to be adjusted, the target length of the pilot may be adjusted.

In some embodiments, after the target length of the pilot is determined, the target transmit power of the pilot may be redetermined, for example, determined based on the target configuration parameter table, or determined based on system presetting or protocol provisions, or any value may be determined.

In some embodiments, the method further includes:

if determining, based on the received second feedback information, that adjusting the target configuration parameter of the pilot is required, continuing to adjust the target configuration parameter of the pilot.

In some embodiments, after the target length of the pilot is readjusted, it is possible to continue to determine whether the target configuration parameter of the pilot needs to be adjusted, and adjust the target length of the pilot and/or the target transmit power of the pilot based on the foregoing content each time the target configuration parameter of the pilot needs to be adjusted.

The current target length of the pilot is l₁, and the transmit power corresponding to the current target length of the pilot in the pilot length and power indication table includes: p₁, p₂, p₃, and p₄, where p₁ <p₂ <p₃ < p₄. If the current target length of the pilot is l₁, after the current target transmit power is adjusted to the highest p₄, if it is determined that the target configuration parameter still needs to be adjusted, the current target length of the pilot may be increased, for example, the target length of the pilot is set to l₂, where l₂ > l₁, and so on, until it is determined that the target configuration parameter does not need to be adjusted.

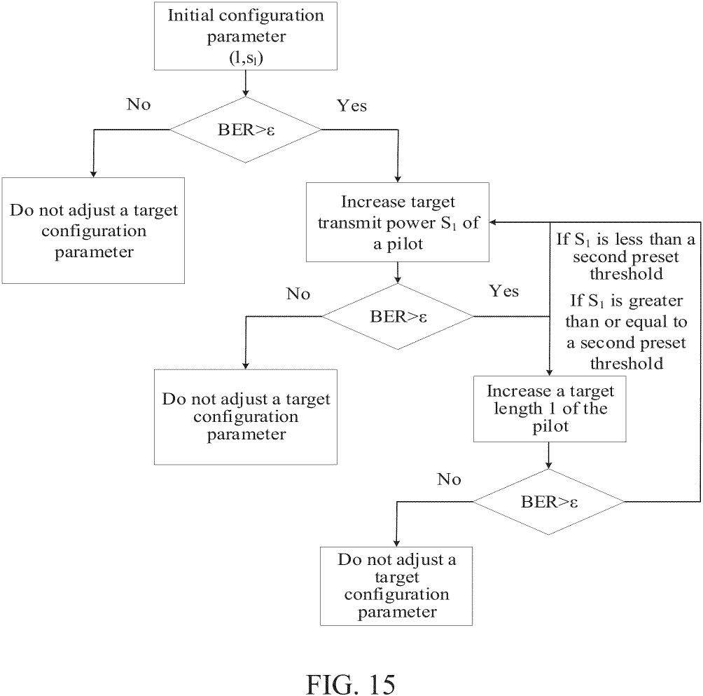

In some embodiments, assuming that the decoding related information is a BER, FIG. 15 is a first schematic diagram of a method for adjusting the target configuration parameter according to an embodiment of this application. As shown in FIG. 15, a process of selecting a pilot parameter may be as follows:

(1) The target communication device initially selects a pilot occupying fewest resources and multiplexes the pilot with data in a same delay-Doppler resource block for transmission.

In some embodiments, the communication peer needs to know a configuration of the pilot.

In some embodiments, the communication peer may know the configuration of the pilot in the following manner:
sequence blind detection by the receiver; or
prior detection/indication of other signals/channels, for example, by synchronization signal indication, or by message indication in a PBCH/PDCCH, which is not limited in this embodiment.

(2) The communication peer decodes a data packet in a current slot or several slots, collects statistics of a BER, and sends a second feedback message to a transmitter based on the BER.

In some embodiments, the second feedback information includes: the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

(3) The target communication device determines, based on the received second feedback message, whether to adjust the pilot parameter.

(4) The corresponding target transmit power may be first adjusted based on the target length of the current pilot.

(5) After it is determined that adjusting the target configuration parameter of the pilot is required, it is possible to further determine whether the target transmit power of the pilot is greater than or equal to the second preset threshold, and if yes, the target length 1 of the pilot may be increased, and the corresponding target transmit power may be adjusted based on the increased target length 1 of the pilot after it is determined that adjusting the target configuration parameter of the pilot is required next time.

In some embodiments, the pilot may continue to be transmitted based on the updated pilot parameter. The foregoing process of (2) to (5) is repeated cyclically until it is determined that the target configuration parameter can no longer be adjusted.

In some embodiments, in a case that a communication peer of the target communication device is a terminal, the adjusting the target configuration parameter of the pilot includes:

decreasing a target overlap-mapped pilot quantity based on the target configuration parameter table and a target length of the pilot.

In some embodiments, in a case that the mapping of the pilot to the pilot resource block in delay-Doppler domain is an overlap mapping, the target configuration parameter table may be a pilot length and overlap quantity indication table, as shown in the following Table 2:

TABLE 2

Pilot length and overlap quantity indication

| Index | Pilot length | Quantity of pilots overlap-placed |
|---|---|---|
| 1 | l₁ | k₁ |
| | | k₂ |
| | | ... |
| 2 | l₂ | k₁ |
| | | k₂ |
| 3 | l₃ | k₁ |
| | | k₂ |
| | | ... |
| 4 | ... | ... |

It should be noted that Table 2 is used only as an example of the target configuration parameter table and does not serve as a limitation on the target configuration parameter table.

In some embodiments, all target overlap-mapped quantities corresponding to the current target length of the pilot may be found in the target configuration parameter table based on the current target length of the pilot, and a target overlap-mapped pilot quantity smaller than a current target overlap-mapped pilot quantity is determined.

For example, the current target length of the pilot is l₁, and target overlap-mapped quantities corresponding to the current target length of the pilot in the pilot length and overlap quantity indication table include k₁, k₂, k₃, ..., where k₁ > k₂ > k₃>.... If the current target length of the pilot is l₁, and the current target overlap-mapped pilot quantity is k₁, and it is determined that the target configuration parameter needs to be adjusted, the target overlap-mapped pilot quantity may be adjusted to k₂, or in some embodiments, may be adjusted to k₃.

In some embodiments, when the target overlap-mapped pilot quantity is adjusted and decreased based on the target configuration parameter table and the target length of the pilot, the target overlap-mapped pilot quantity may be decreased sequentially in descending order of target overlap-mapped quantities in the target configuration parameter table, or any quantity less than the current quantity may be selected to decrease the target overlap-mapped pilot quantity, or the target overlap-mapped pilot quantity may be decreased in descending order of target overlap-mapped quantities in the target configuration parameter table based on a rule with one or more as an interval. This is not limited in this embodiment.

In some embodiments, in a case that a communication peer of the target communication device is a terminal, the adjusting the target configuration parameter of the pilot includes:

decreasing a target overlap-mapped pilot quantity based on the preset adjustment value and a target length of the pilot.

In some embodiments, in a case that the mapping of the pilot to the pilot resource block in delay-Doppler domain is an overlap mapping, the target overlap-mapped pilot quantity may be decreased based on the current target length of the pilot and the preset adjustment value.

For example, the current target length of the pilot is l₁, the current target transmit power is k₁, and the preset adjustment value is b, where b is a positive number; and if it is determined that the target configuration parameter needs to be adjusted, the target transmit power may be adjusted to k₁ - m×b, where m≥1.

In some embodiments, the method further includes: if determining, based on received third feedback information, that adjusting the target configuration parameter of the pilot is required, and determining that the target overlap-mapped pilot quantity is greater than a third preset threshold, continuing to adjust the target configuration parameter of the pilot, where the third preset threshold includes a preset value, or a smallest overlap-mapped quantity corresponding to the target length of the pilot in the target configuration parameter table.

In some embodiments, in a case of an overlap mapping of the pilot, after the target configuration parameter of the pilot is adjusted, the target configuration parameter may be transmitted together with data to the communication peer; and the communication peer may obtain the decoding related information after performing decoding, and transmit the third feedback information to the target communication device based on the decoding related information.

It may be understood that the first feedback information and the third feedback information, and the manners of obtaining the first feedback information and the third feedback information are similar.

In some embodiments, the third feedback information includes:

the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

In some embodiments, because the third feedback information is obtained by the communication peer after the communication peer decodes the data packet and obtains the decoding related information, the third feedback information may be directly the decoding related information, that is, the communication peer of the target communication device may directly transmit the decoding related information to the target communication device, so that the target communication device determines, based on the decoding related information, whether the target configuration parameter of the pilot needs to be adjusted.

In some embodiments, because the third feedback information is obtained by the communication peer after the communication peer decodes the data packet and obtains the decoding related information, the third feedback information may be the indication information for adjusting the target configuration parameter, transmitted by the communication peer to the target communication device after the communication peer determines, based on the decoding related information, that adjusting the target configuration parameter of the pilot is required, where the indication information for adjusting the target configuration parameter is used to instruct the target communication device to adjust the target configuration parameter, so that the target communication device determines, after receiving the indication information for adjusting the target configuration parameter, that adjusting the target configuration parameter of the pilot is required.

In some embodiments, the decoding related information may be a BER or may be similar information in a decoding result.

In some embodiments, the determining, based on received third feedback information, that adjusting the target configuration parameter of the pilot is required includes:
determining, based on the decoding related information, that the target configuration parameter needs to be adjusted; or
determining, based on the indication information for adjusting the target configuration parameter, that the target configuration parameter needs to be adjusted.

In some embodiments, the determining, based on the decoding related information, that the target configuration parameter needs to be adjusted includes:

in a case that the decoding related information is greater than a first preset threshold, determining that the target configuration parameter needs to be adjusted.

A target value of the decoding related information, that is, the first preset threshold, may be preset in the system or specified in a protocol. In a case of determining and finding that the decoding related information is greater than the first preset threshold, it may be determined that the target configuration parameter needs to be adjusted.

In some embodiments, the decoding related information may be determined by the length of the pilot and the overlap-mapped pilot quantity. For example, the decoding related information is a BER and may be denoted as bler(l,k), where l is the length of the pilot, and k is the quantity of pilots.

In some embodiments, the target BER of the current service may be preset to ε, that is, the first preset threshold. In this case, only the smallest l and the largest k that satisfy ber(l,k) ≤ ε need to be selected as the target configuration parameter to reduce the overheads maximally, so that the target configuration parameter can be adjusted in a case of determining and finding ber(l,k) > ε.

In some embodiments, after it is determined, based on the received third feedback information, that adjusting the target configuration parameter of the pilot is required, it is possible to further determine whether the target overlap-mapped pilot quantity is greater than the third preset threshold, and continue to adjust the target configuration parameter of the pilot if the target overlap-mapped pilot quantity is greater than the third preset threshold, for example, continue to decrease the target overlap-mapped pilot quantity.

In some embodiments, the method further includes: if determining, based on received third feedback information, that adjusting the target configuration parameter of the pilot is required, and determining that the target overlap-mapped pilot quantity is less than or equal to a third preset threshold, increasing the target length of the pilot.

In some embodiments, the third preset threshold of the target overlap-mapped pilot quantity corresponds to the target length of the pilot, and each length of the pilot may correspond to a different or same third preset threshold of the target overlap-mapped pilot quantity.

In some embodiments, if the target overlap-mapped pilot quantity is less than or equal to the third preset threshold in a case that the target length of the pilot remains unchanged, it may be considered that transmission performance is already optimal at the current target length of the pilot, and if transmission performance better than current transmission performance is required, the target length of the pilot may be adjusted, for example, the target length of the pilot is increased.

In some embodiments, after it is determined, based on the received third feedback information, that adjusting the target configuration parameter of the pilot is required, it is possible to further determine whether the target overlap-mapped pilot quantity is greater than the third preset threshold; and if the target overlap-mapped pilot quantity is less than or equal to the third preset threshold, it may be considered that transmission performance is already optimal at the current target length of the pilot. However, because the target configuration parameter of the pilot still needs to be adjusted, the target length of the pilot may be adjusted.

In some embodiments, after the target length of the pilot is determined, the target overlap-mapped pilot quantity may be redetermined, for example, determined based on the target configuration parameter table, or determined based on system presettings or protocol provisions, or any value may be determined.

In some embodiments, the method further includes:

if determining, based on the received third feedback information, that adjusting the target configuration parameter of the pilot is required, continuing to adjust the target configuration parameter of the pilot.

In some embodiments, after the target length of the pilot is readjusted, it is possible to continue to determine whether the target configuration parameter of the pilot needs to be adjusted, and adjust the target length of the pilot and/or the target overlap-mapped pilot quantity based on the foregoing content each time the target configuration parameter of the pilot needs to be adjusted.

The current target length of the pilot is l₁, and overlap-mapped quantities corresponding to the current target length of the pilot in the target configuration parameter table include: k₁, k₂, k₃, and k₄; where k₁ > k₂ > k₃ > k₄. If the current target length of the pilot is l₁, after the current target overlap-mapped pilot quantity is adjusted to the smallest k₄, if it is determined that the target configuration parameter still needs to be adjusted, the current target length of the pilot may be increased, for example, the target length of the pilot is set to l₂, where l₂ > l₁, and so on, until it is determined that the target configuration parameter does not need to be adjusted.

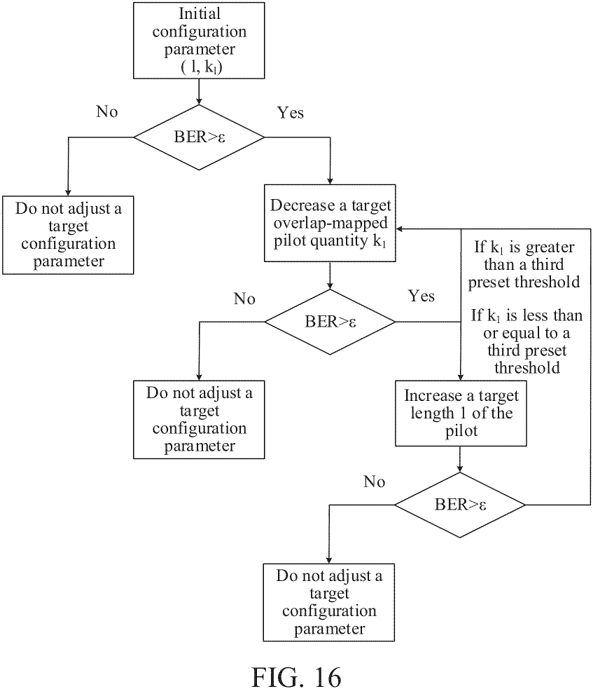

In some embodiments, assuming that the decoding related information is a BER, FIG. 16 is a second schematic diagram of a method for adjusting the target configuration parameter according to an embodiment of this application. As shown in FIG. 16, a process of selecting a pilot parameter may be as follows:

(1) The target communication device initially selects a pilot length occupying fewest resources and a largest overlapped pilot quantity corresponding to the pilot length, and multiplexes the pilot length and the largest overlapped pilot quantity with data in a same delay-Doppler resource block for transmission.

In some embodiments, the communication peer needs to know a configuration of the pilot.

In some embodiments, the communication peer may know the configuration of the pilot in the following manner:
sequence blind detection by the receiver; or
prior detection/indication of other signals/channels, for example, by synchronization signal indication, or by message indication in a PBCH/PDCCH, which is not limited in this embodiment.

(2) The communication peer decodes a data packet in a current slot or several slots, collects statistics of a BER, and sends a third feedback message to a transmitter based on the BER.

In some embodiments, the third feedback information includes: the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

(3) The target communication device determines, based on the received third feedback message, whether to adjust the target configuration parameter.

(4) The corresponding target overlap-mapped pilot quantity may be first adjusted based on the target length of the current pilot.

(5) After it is determined that adjusting the target configuration parameter of the pilot is required, it is possible to further determine whether the target overlap-mapped pilot quantity is less than or equal to the third preset threshold, and if yes, the target length 1 of the pilot may be increased, and the corresponding target overlap-mapped pilot quantity may be adjusted based on the increased target length 1 of the pilot after it is determined that adjusting the target configuration parameter of the pilot is required next time.

In some embodiments, the pilot may continue to be configured and transmitted based on the updated target configuration parameter. The foregoing process of (2) to (5) is repeated cyclically until it is determined that the target configuration parameter can no longer be adjusted.

In some embodiments, the method further includes:

indicating the target configuration parameter to the communication peer based on first indication information.

In some embodiments, the target configuration parameter may be indicated to the communication peer based on the first indication information, so that the communication peer knows the configuration of the pilot.

In some embodiments, the communication peer may know the configuration of the pilot by performing sequence blind detection, or by prior detection/indication of other signals/channels.

In some embodiments, when the target communication device is a network-side device, the first indication information may be carried by synchronization information, or carried by a physical downlink control channel PDCCH or a physical broadcast channel PBCH.

In some embodiments, when the target communication device is a terminal and the communication peer is a network-side device, the first indication information is carried by synchronization information, or carried by a physical uplink control channel PUCCH or a physical broadcast channel PBCH.

In some embodiments, when the target communication device is a terminal and the communication peer is a terminal, the first indication information is carried by sidelink control signaling or a synchronization message, or carried by a physical sidelink control channel PSCCH or a physical sidelink shared channel PSSCH or a sidelink broadcast control channel SBCCH.

In some embodiments, the method further includes:
multiplexing an initial pilot and data on the pilot resource block for transmission, where
the initial pilot is obtained based on a configuration of an initial configuration parameter.

Before the pilot is adjusted, the initial pilot may be first obtained based on the configuration of the initial configuration parameter, and the initial pilot and the data are multiplexed on the pilot resource block for transmission, so that the communication peer can perform decoding to obtain the decoding related information and send the first feedback information based on the decoding related information.

It may be understood that this embodiment is merely one of the manners of obtaining the first feedback information, but not the only one.

In some embodiments, the initial configuration parameter is preset, or the initial configuration parameter is selected from a target configuration parameter table.

In some embodiments, the initial configuration parameter may be preset in the system, or may be preset in a protocol.

In some embodiments, a target configuration parameter may be selected randomly from the target configuration parameter table or based on a rule such as selecting a target configuration parameter corresponding to a c^{th} index in the table, where c is a positive integer. The selection manner is not limited in this embodiment.

In some embodiments, in a case that the target configuration parameter of the pilot includes the target length and target transmit power of the pilot, the initial configuration parameter includes a configuration parameter that causes the initial pilot to occupy fewest resources.

In some embodiments, when the initial configuration parameter is determined, the configuration parameter that causes the initial pilot to occupy fewest resources may be determined.

In some embodiments, in a case of a single-point mapping of the pilot, a configuration parameter with a shortest pilot length is selected.

In some embodiments, in a case that the target configuration parameter of the pilot includes the target length of the pilot and the target overlap-mapped pilot quantity, the initial configuration parameter includes a first pilot length, and/or a first overlap-mapped quantity corresponding to the first pilot length, where

a pilot of the first pilot length occupies fewest resources; and the first overlap-mapped quantity is a largest overlap-mapped quantity corresponding to the first pilot length.

In some embodiments, in a case of an overlap mapping of the pilot, a combination of configuration parameters of the shortest pilot length and the largest overlap-mapped pilot quantity corresponding to the length is selected.

In some embodiments, the method further includes:

indicating the initial configuration parameter and/or the target configuration parameter to the communication peer based on second indication information.

In some embodiments, the initial configuration parameter and/or the target configuration parameter may be indicated to the communication peer based on the second indication information, so that the communication peer knows the configuration of the pilot.

In some embodiments, the communication peer may know the configuration of the pilot by performing sequence blind detection, or by prior detection/indication of other signals/channels.

In some embodiments, when the target communication device is a network-side device, the second indication information may be carried by synchronization information, or carried by a physical downlink control channel PDCCH or a physical broadcast channel PBCH.

In some embodiments, when the target communication device is a terminal and the communication peer is a network-side device, the second indication information is carried by synchronization information, or carried by a physical uplink control channel PUCCH or a physical broadcast channel PBCH.

In some embodiments, when the target communication device is a terminal and the communication peer is a terminal, the second indication information is carried by sidelink control signaling or a synchronization message, or carried by a physical sidelink control channel PSCCH or a physical sidelink shared channel PSSCH or a sidelink broadcast control channel SBCCH.

In some embodiments, the second indication information includes:
the initial configuration parameter and/or the target configuration parameter; or
first index information, where the first index information is used to indicate the initial configuration parameter and/or the target configuration parameter.

In some embodiments, values of the initial configuration parameter and/or the target configuration parameter may be directly notified to the communication peer by using the second indication information.

In some embodiments, first index information corresponding to the initial configuration parameter and/or the target configuration parameter in the target configuration parameter table may be sent to the communication peer, so that the communication peer determines the initial configuration parameter and/or the target configuration parameter in the target configuration parameter table based on the first index information.

In some embodiments, the method further includes:

determining a target shape of the pilot resource block.

In some embodiments, the pilot overheads may vary depending on different target shapes of the pilot resource block.

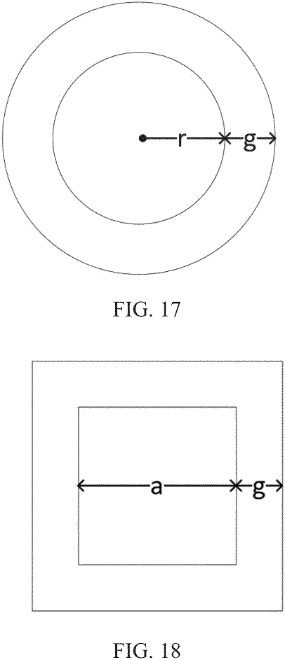

In some embodiments, a non-square resource mapping pattern may also be considered. A reason is that a non-square pilot signal resource block may reduce overheads in a specific scenario. FIG. 17 is a first schematic diagram of a shape of a pilot resource block according to an embodiment of this application. FIG. 18 is a second schematic diagram of a shape of a pilot resource block according to an embodiment of this application. As shown in FIG. 17 and FIG. 18, a square mapping and a circular mapping are used as an example. A small inner circle (with a radius r) and a small inner square (with a side length a) in the figures are resources occupied by the pilot, and a circular ring and a square ring are resources occupied by the pilot guard band. Assuming that the length of the pilot is A, the following formulas are satisfied:

$$r = \sqrt{\frac{A}{π}} ; \text{and}$$

$$a = \sqrt{A} .$$

Therefore, to simplify analysis, it can be assumed that widths of the pilot guard band in a delay dimension and a Doppler dimension are equal and both are equal to g. Pilot guard band overheads in the circular and square mappings are respectively:

$${C}_{c i r c l e} = π {\left(r + g\right)}^{2} - A = 2 π \text{} r g + π \text{} {g}^{2} = 2 \sqrt{π \text{} A} g + π \text{} {g}^{2} ; \text{and}$$

$${C}_{s q u a r e} = {\left(a + 2 g\right)}^{2} - A = 4 a g + 4 {g}^{2} = 4 \sqrt{A} g + 4 {g}^{2} .$$

As can be easily learned, ∀g ≥ 0, and C_{circle} ≤ C_{square}.

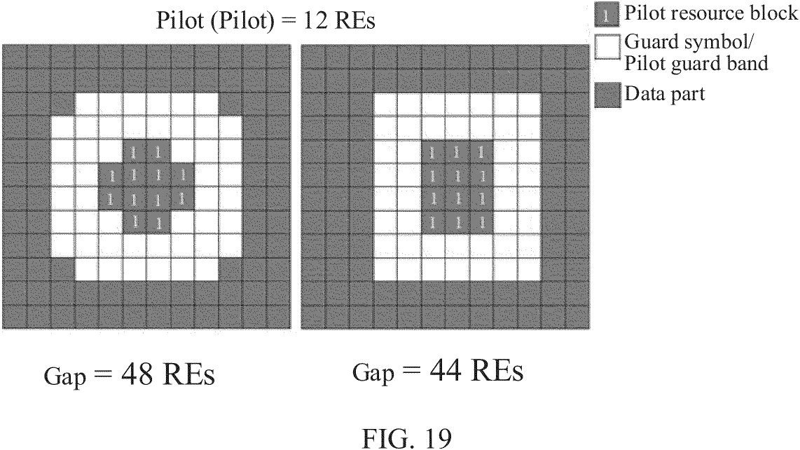

However, in an actual system, because a pilot is mapped in a form of a discrete grid and its edges are not smooth curves, the foregoing circular pilot resource block can only be implemented approximately and therefore may not be applicable in some cases. FIG. 19 is a third schematic diagram of a shape of a pilot resource block according to an embodiment of this application.

Because a closed-form expression cannot be derived from a guard band quantity relationship in a discrete grid mapping, closed-form expressions need to be discussed one by one in specific cases, and there is no need to list the closed-form expressions herein. However, simple analysis based on the foregoing formula may be as follows:

$$\begin{matrix}{C}_{s q u a r e} - {C}_{c i r c l e} = 4 \sqrt{A} g + 4 {g}^{2} - 2 \sqrt{π \text{} A} - π \text{} {g}^{2} = \left(4 - 2 \sqrt{π}\right) \sqrt{A} g + \\ \left(4 - π\right) {g}^{2} = \left(4 - π\right) {\left(g + \frac{1}{2 + \sqrt{π}}\right)}^{2} - \frac{2 - \sqrt{π}}{2 + \sqrt{π}} .\end{matrix}$$

Therefore, the pilot overhead in the square mapping is higher than the pilot overhead in the circular mapping, presented as a monotonically increasing parabola in an interval g ∈ [0,∞), and the larger g is, the faster the overhead increases.

Therefore, pilot resource block mappings in different shapes have their own advantages and disadvantages in terms of overheads under different conditions, and the overheads are related to values of (g,A). Starting from this, different shapes of the pilot resource blocks can be designed, and after (g,A) is selected, corresponding mapping patterns can be used, so that overheads of their guard bands are lowest.

In some embodiments, the target shape of the pilot resource block includes:

a closed graph enclosed by a curve or a broken line.

In some embodiments, the target shape of the pilot resource block may be a rectangle, such as a rectangle or a square.

In some embodiments, the target shape of the pilot resource block may be a closed graph enclosed by a curve or a broken line, such as a circle or an ellipse.

In some embodiments, the target shape of the pilot resource block is scaled based on a length and width of a resource grid in delay-Doppler domain.

In some embodiments, the shape of the pilot signal resource block may be scaled with the shape of the current delay-Doppler resource grid in proportion to the length and width.

For example, when the current delay-Doppler resource grid is a square, the shape of the pilot signal resource block may be a square or a circle; or when the current delay-Doppler resource grid is a rectangle, the current delay-Doppler resource grid may be a rectangle or an ellipse.

In some embodiments, the determining a shape of the pilot resource block includes:

determining the target shape of the pilot resource block based on a width of a pilot guard band and the target length of the pilot.

In some embodiments, a length/width or long/short axis of the pilot signal resource block and a length/width of the delay-Doppler resource grid may be in an equal scaling relationship.

In some embodiments, the width of the pilot guard band is obtained through calculation based on channel quality information.

In some embodiments, to prevent pollution of a pilot symbol by data on a receive signal grid, which otherwise leads to inaccurate channel estimation, the size of the pilot guard band should satisfy the following conditions:

$${l}_{τ} \geq {τ}_{m a x} M Δ f ; \text{and}$$

$${k}_{v} \geq {v}_{m a x} N Δ T ,$$

where τₘₐₓ and vₘₐₓ are a maximum delay and a maximum Doppler frequency shift for all paths of the channel respectively.

In some embodiments, the determining the shape of the pilot resource block based on a width of a pilot guard band and the target length of the pilot includes:
determining the target shape of the pilot resource block in a pilot resource block shape indication table based on the width of the pilot guard band and the target length of the pilot, where
in the pilot resource block shape indication table, the target shape of the pilot resource block corresponds to the width of the pilot guard band and the target length of the pilot.

In some embodiments, a pilot resource block shape indication table may be defined. In the table, an association relationship between (g,A) and the shape of the pilot mapping is determined, so that the target shape of the pilot resource block is determined and indicated.

TABLE 3

Pilot resource block indication

| Index | Guard band width and pilot length | Pilot sequence mapping pattern |
|---|---|---|
| 0 | (g₀,A₀) | pattern 0 |
| 1 | (g₁,A₁) | pattern 1 |
| 2 | (g₂,A₂) | pattern 2 |
| 3 | ... | ... |

In some embodiments, after the pilot length and the guard band width are determined, the target shape of the pilot resource block may be determined in the pilot resource block shape indication table based on the width of the pilot guard band and the target length of the pilot.

In some embodiments, the target shape of the pilot resource block may be redetermined after the pilot length is determined each time.

In some embodiments, among shapes of all pilot resource blocks corresponding to the width of the pilot guard band and the target length of the pilot, the target shape occupies fewest pilot resource blocks.

In some embodiments, when the target shape of the pilot resource block is determined in the pilot resource block shape indication table based on the width of the pilot guard band and the target length of the pilot, a target shape that minimizes a quantity of pilot resource blocks may be determined among all shapes corresponding to the width of the pilot guard band and the target length of the pilot in the pilot resource block indication table.

In some embodiments, the method further includes:

indicating the target shape of the pilot resource block to the communication peer based on third indication information.

In some embodiments, the target shape of the pilot resource block may be indicated to the communication peer based on the third indication information, so that the communication peer knows the configuration of the pilot and the shape of the pilot resource block.

In some embodiments, when the target communication device is a network-side device, the third indication information may be carried by synchronization information, or carried by a physical downlink control channel PDCCH or a physical broadcast channel PBCH.

In some embodiments, when the target communication device is a terminal and the communication peer is a network-side device, the third indication information is carried by synchronization information, or carried by a physical uplink control channel PUCCH or a physical broadcast channel PBCH.

In some embodiments, when the target communication device is a terminal and the communication peer is a terminal, the third indication information is carried by sidelink control signaling or a synchronization message, or carried by a physical sidelink control channel PSCCH or a physical sidelink shared channel PSSCH or a sidelink broadcast control channel SBCCH.

In some embodiments, the third indication information includes:
the target shape of the pilot resource block, and the width of the pilot guard band and the target length of the pilot corresponding to the target shape of the pilot resource block in the pilot resource block shape indication table; or
second index information, where the second index information is used to indicate the target shape of the pilot resource block, and the width of the pilot guard band and the target length of the pilot corresponding to the target shape of the pilot resource block in the pilot resource block shape indication table.

In some embodiments, the target communication device may indicate the target shape of the pilot resource block, and the width of the pilot guard band and the target length of the pilot corresponding to the target shape of the pilot resource block in the pilot resource block shape indication table to the communication peer.

In some embodiments, the target communication device may indicate the target shape of the pilot resource block, and the second index information in the pilot resource block shape indication table about the width of the pilot guard band and the target length of the pilot corresponding to the target shape of the pilot resource block in the pilot resource block shape indication table to the communication peer.

In some embodiments, the method further includes:

indicating the pilot resource block shape indication table to the communication peer based on fourth indication information.

In some embodiments, the pilot resource block shape indication table may be first indicated to the communication peer based on the fourth indication information, so that the communication peer can determine the related configuration of the pilot resource block based on the pilot resource block shape indication table and the second index information.

In some embodiments, when the target communication device is a network-side device, the fourth indication information may be carried by synchronization information, or carried by a physical downlink control channel PDCCH or a physical broadcast channel PBCH.

In some embodiments, when the target communication device is a terminal and the communication peer is a network-side device, the fourth indication information is carried by synchronization information, or carried by a physical uplink control channel PUCCH or a physical broadcast channel PBCH.

In some embodiments, when the target communication device is a terminal and the communication peer is a terminal, the fourth indication information is carried by sidelink control signaling or a synchronization message, or carried by a physical sidelink control channel PSCCH or a physical sidelink shared channel PSSCH or a sidelink broadcast control channel SBCCH.

In some embodiments, the method further includes:
indicating, based on fifth indication information, that a first pilot adjustment process is to be triggered or stopped, where
the first pilot adjustment process includes: determining, based on the received first feedback information and/or second pilot information, that adjusting the target configuration parameter of the pilot is required.

In some embodiments, in a scenario in which a time-variant feature of the channel is not significant, to reduce pilot adaptive feedback overheads, the transmit end may trigger or terminate the pilot adjustment process by using a specific indication message.

In some embodiments, when the target communication device is a network-side device, the fifth indication information may be carried by synchronization information, or carried by a physical downlink control channel PDCCH or a physical broadcast channel PBCH.

In some embodiments, when the target communication device is a terminal and the communication peer is a network-side device, the fifth indication information is carried by synchronization information, or carried by a physical uplink control channel PUCCH or a physical broadcast channel PBCH.

In some embodiments, when the target communication device is a terminal and the communication peer is a terminal, the fifth indication information is carried by sidelink control signaling or a synchronization message, or carried by a physical sidelink control channel PSCCH or a physical sidelink shared channel PSSCH or a sidelink broadcast control channel SBCCH.

In some embodiments, the method further includes:
indicating a feedback period of the communication peer based on sixth indication information, where
the feedback period includes a time window for collecting statistics of the decoding related information and/or a transmission period of a feedback message.

In some embodiments, to avoid frequent transmission of feedback messages, the target communication device may indicate, by using the sixth indication information, the time window for collecting statistics of the decoding related information such as a BER and/or a transmission period of a feedback message.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

It should be noted that the pilot transmission method provided in this embodiment of this application may be performed by a pilot transmission apparatus, or a control module for performing the pilot transmission method in the pilot transmission apparatus. A pilot transmission apparatus provided in an embodiment of this application is described by using an example in which the pilot transmission apparatus performs the pilot transmission method in this embodiment of this application.

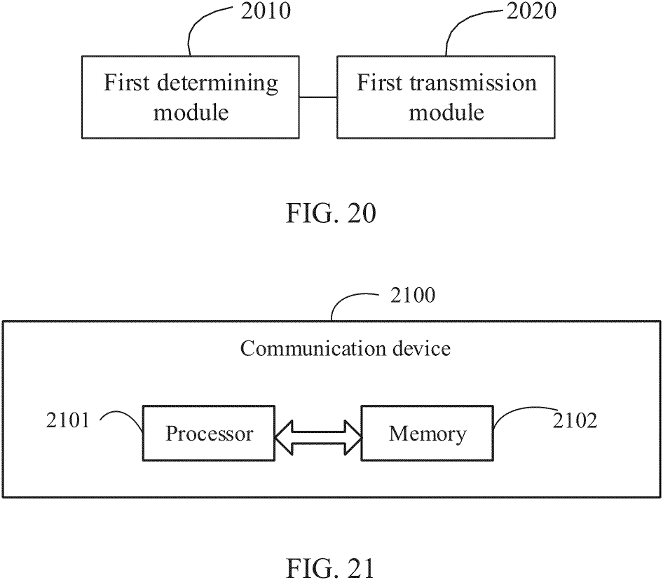

FIG. 20 is a schematic diagram of a structure of a pilot transmission apparatus according to an embodiment of this application. The apparatus is applied to a target communication device. The apparatus includes a first determining module 2010 and a first transmission module 2020, where
the first determining module 2010 is configured to determine a target configuration parameter of a pilot; and
the first transmission module 2020 is configured to map, based on the target configuration parameter, the pilot to a pilot resource block in delay-Doppler domain for transmission.

In some embodiments, the pilot transmission apparatus determines the target configuration parameter of the pilot by using the first determining module 2010; and then maps, based on the target configuration parameter by using the first transmission module 2020, the pilot to the pilot resource block in delay-Doppler domain for transmission.

It should be noted herein that the foregoing apparatus provided in this embodiment of this application can implement all method steps implemented by the pilot transmission method embodiment, with the same technical effect achieved, and parts and effects of this embodiment same as those of the method embodiment are not described in detail herein.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

In some embodiments, in a case that a communication peer of the target communication device is a terminal or a network-side device, the target configuration parameter of the pilot includes: a target length of the pilot and target transmit power of the pilot.

In some embodiments, in a case that a communication peer of the target communication device is a terminal, the target configuration parameter of the pilot includes:

a target length of the pilot and a target overlap-mapped pilot quantity.

In some embodiments, the apparatus further includes:
a second determining module, configured to determine, based on received first feedback information, that adjusting the target configuration parameter of the pilot is required, where
the first feedback information is obtained after a communication peer decodes a data packet and obtains decoding related information.

In some embodiments, the first feedback information includes: the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

In some embodiments, the second determining module is configured to:

in a case that the decoding related information is greater than a first preset threshold, determine that the target configuration parameter needs to be adjusted.

In some embodiments, the second determining module is configured to:
adjust the target configuration parameter of the pilot based on a target configuration parameter table, where
the target configuration parameter table is specified in a protocol in advance.

In some embodiments, the second determining module is further configured to:
adjust the target configuration parameter of the pilot based on a preset adjustment value, where
the preset adjustment value is specified in a protocol in advance.

In some embodiments, in a case that a communication peer of the target communication device is a terminal or a network-side device, the second determining module is further configured to:

increase target transmit power of the pilot based on the target configuration parameter table and a target length of the pilot.

In some embodiments, in a case that a communication peer of the target communication device is a terminal or a network-side device, the second determining module is further configured to:

increase target transmit power of the pilot based on the preset adjustment value and a target length of the pilot.

In some embodiments, the apparatus further includes:

a first adjustment module, configured to: if it is determined, based on received second feedback information, that adjusting the target configuration parameter of the pilot is required, and it is determined that the target transmit power of the pilot is less than a second preset threshold, continue to adjust the target configuration parameter of the pilot, where the second preset threshold includes a preset value, or highest transmit power corresponding to the target length of the pilot in the target configuration parameter table.

In some embodiments, the apparatus further includes:

a first increasing module, configured to: if it is determined, based on received second feedback information, that adjusting the target configuration parameter of the pilot is required, and it is determined that the target transmit power of the pilot is greater than or equal to a second preset threshold, increase the target length of the pilot.

In some embodiments, the apparatus further includes:

a second adjustment module, configured to: if it is determined, based on the received second feedback information, that adjusting the target configuration parameter of the pilot is required, continue to adjust the target configuration parameter of the pilot.

In some embodiments, in a case that a communication peer of the target communication device is a terminal, the second determining module is further configured to:

decrease a target overlap-mapped pilot quantity based on the target configuration parameter table and a target length of the pilot.

In some embodiments, in a case that a communication peer of the target communication device is a terminal, the second determining module is further configured to:

decrease a target overlap-mapped pilot quantity based on the preset adjustment value and a target length of the pilot.

In some embodiments, the apparatus further includes:

a third adjustment module, configured to: if it is determined, based on received third feedback information, that adjusting the target configuration parameter of the pilot is required, and it is determined that the target overlap-mapped pilot quantity is greater than a third preset threshold, continue to adjust the target configuration parameter of the pilot, where the third preset threshold includes a preset value, or a smallest overlap-mapped quantity corresponding to the target length of the pilot in the target configuration parameter table.

In some embodiments, the apparatus further includes:

a second increasing module, configured to: if it is determined, based on received third feedback information, that adjusting the target configuration parameter of the pilot is required, and it is determined that the target overlap-mapped pilot quantity is less than or equal to a third preset threshold, increase the target length of the pilot.

In some embodiments, the apparatus further includes:

a fourth adjustment module, configured to: if it is determined, based on the received third feedback information, that adjusting the target configuration parameter of the pilot is required, continue to adjust the target configuration parameter of the pilot.

In some embodiments, the apparatus further includes:

a first indication module, configured to indicate the target configuration parameter to the communication peer based on first indication information.

In some embodiments, the apparatus further includes:
a multiplexing module, configured to multiplex an initial pilot and data on the pilot resource block for transmission, where
the initial pilot is obtained based on a configuration of an initial configuration parameter.

In some embodiments, the initial configuration parameter is preset, or the initial configuration parameter is selected from a target configuration parameter table.

In some embodiments, in a case that the target configuration parameter of the pilot includes the target length and target transmit power of the pilot, the initial configuration parameter includes a configuration parameter that causes the initial pilot to occupy fewest resources.

In some embodiments, in a case that the target configuration parameter of the pilot includes the target length of the pilot and the target overlap-mapped pilot quantity, the initial configuration parameter includes a first pilot length, and/or a first overlap-mapped quantity corresponding to the first pilot length, where

a pilot of the first pilot length occupies fewest resources; and the first overlap-mapped quantity is a largest overlap-mapped quantity corresponding to the first pilot length.

In some embodiments, the apparatus further includes:

a second indication module, configured to indicate the initial configuration parameter and/or the target configuration parameter to the communication peer based on second indication information.

In some embodiments, the second indication information includes:
the initial configuration parameter and/or the target configuration parameter; or
first index information, where the first index information is used to indicate the initial configuration parameter and/or the target configuration parameter.

In some embodiments, the apparatus further includes:

a third determining module, configured to determine a target shape of the pilot resource block.

In some embodiments, the target shape of the pilot resource block includes:

a closed graph enclosed by a curve or a broken line.

In some embodiments, the target shape of the pilot resource block is scaled based on a length and width of a resource grid in delay-Doppler domain.

In some embodiments, the third determining module is configured to:

determine the target shape of the pilot resource block based on a width of a pilot guard band and a target length of the pilot.

In some embodiments, the width of the pilot guard band is obtained through calculation based on channel quality information.

In some embodiments, the third determining module is configured to:
determine the target shape of the pilot resource block in a pilot resource block shape indication table based on the width of the pilot guard band and the target length of the pilot, where
in the pilot resource block shape indication table, the target shape of the pilot resource block corresponds to the width of the pilot guard band and the target length of the pilot.

In some embodiments, among shapes of all pilot resource blocks corresponding to the width of the pilot guard band and the target length of the pilot, the target shape occupies fewest pilot resource blocks.

In some embodiments, the apparatus further includes:

a third indication module, configured to indicate the target shape of the pilot resource block to the communication peer based on third indication information.

In some embodiments, the third indication information includes:
the target shape of the pilot resource block, and the width of the pilot guard band and the target length of the pilot corresponding to the target shape of the pilot resource block in the pilot resource block shape indication table; or
second index information, where the second index information is used to indicate the target shape of the pilot resource block, and the width of the pilot guard band and the target length of the pilot corresponding to the target shape of the pilot resource block in the pilot resource block shape indication table.

In some embodiments, the apparatus further includes:

a fourth indication module, configured to indicate the pilot resource block shape indication table to the communication peer based on fourth indication information.

In some embodiments, the apparatus further includes:
a fifth indication module, configured to indicate, based on fifth indication information, that a first pilot adjustment process is to be triggered or stopped, where
the first pilot adjustment process includes: determining, based on the received first feedback information and/or second pilot information, that adjusting the target configuration parameter of the pilot is required.

In some embodiments, the apparatus further includes:
a sixth indication module, configured to indicate a feedback period of the communication peer based on sixth indication information, where
the feedback period includes a time window for collecting statistics of the decoding related information and/or a transmission period of a feedback message.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

The pilot transmission apparatus in this embodiment of this application may be a terminal, or may be a component, an integrated circuit, or a chip in a terminal. The apparatus may be a mobile terminal, or may be a nonmobile terminal. For example, the mobile terminal may include but is not limited to the foregoing illustrated type of the terminal 11. The nonmobile terminal may be a server, a Network Attached Storage (NAS), a personal computer (PC), a television (TV), a teller machine, a self-service machine, or the like. This is not specifically limited in this embodiment of this application.

The pilot transmission apparatus in this embodiment of this application may be an apparatus having an operating system. The operating system may be an Android operating system, an iOS operating system, or other possible operating systems, and is not specifically limited in this embodiment of this application.

The pilot transmission apparatus provided in this embodiment of this application can implement each process implemented by the method embodiments in FIG. 11 to FIG. 19, with the same technical effect achieved. To avoid repetition, details are not described herein again.

In some embodiments, FIG. 21 is a schematic diagram of a structure of a target communication device according to an embodiment of this application. As shown in FIG. 21, the communication device 2100 includes a processor 2101, a memory 2102, and a program or instructions stored in the memory 2102 and capable of running on the processor 2101. For example, when the communication device 2100 is a terminal, and the program or instructions are executed by the processor 2101, each process of the foregoing pilot transmission method embodiment is implemented, with the same technical effect achieved. When the communication device 2100 is a network-side device, and the program or instructions are executed by the processor 2101, each process of the foregoing pilot transmission method embodiment is implemented, with the same technical effect achieved. To avoid repetition, details are not described herein again.

It may be understood that the target communication device in this application may be a network-side device or may be a terminal.

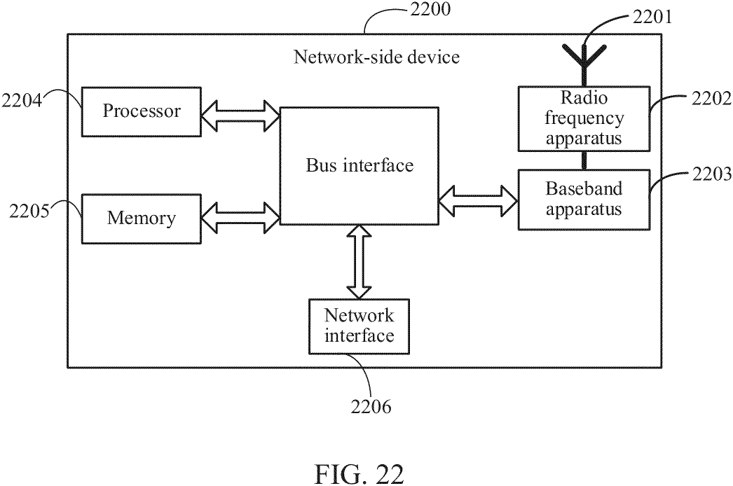

FIG. 22 is a schematic diagram of a hardware structure of a network-side device according to an embodiment of this application.

As shown in FIG. 22, the network-side device 2200 includes an antenna 2201, a radio frequency apparatus 2202, and a baseband apparatus 2203. The antenna 2201 is connected to the radio frequency apparatus 2202. In an uplink direction, the radio frequency apparatus 2202 receives information by using the antenna 2201, and sends the received information to the baseband apparatus 2203 for processing. In a downlink direction, the baseband apparatus 2203 processes to-be-sent information, and sends the information to the radio frequency apparatus 2202; and the radio frequency apparatus 2202 processes the received information and then sends the information out by using the antenna 2201.

The method performed by the network-side device in the foregoing embodiment may be implemented in the baseband apparatus 2203, and the baseband apparatus 2203 includes a processor 2204 and a memory 2205.

The baseband apparatus 2203 may include, for example, at least one baseband unit, where a plurality of chips are disposed on the baseband unit. As shown in FIG. 22, one of the chips is, for example, the processor 2204, connected to the memory 2205, to invoke a program in the memory 2205 to perform the operation of the network device shown in the foregoing method embodiment.

The baseband apparatus 2203 may further include a network interface 2206, configured to exchange information with the radio frequency apparatus 2202, where the interface is, for example, a common public radio interface (CPRI).

In some embodiments, the network-side device in this embodiment of this application further includes a program or instructions stored in the memory 2205 and capable of running on the processor 2204. When the processor 2204 invokes the program or instructions in the memory 2205, the method performed by each module shown in FIG. 20 is performed, with the same technical effect achieved. To avoid repetition, details are not described herein again.

The processor 2204 is configured to:
determine a target configuration parameter of a pilot; and
map, based on the target configuration parameter, the pilot to a pilot resource block in delay-Doppler domain for transmission.

In this embodiment of this application, after the parameter of the pilot is configured, the pilot is mapped to the pilot resource block in delay-Doppler domain for transmission. Because impact of the parameter configuration of the pilot oil pilot overheads and reliability is considered, the pilot overheads are reduced while service reliability is ensured.

In some embodiments, the target configuration parameter of the pilot includes:

a target length of the pilot and target transmit power of the pilot.

In some embodiments, the target configuration parameter of the pilot includes:

a target length of the pilot and a target overlap-mapped pilot quantity.

In some embodiments, the processor 2204 is further configured to:
determine, based on received first feedback information, that adjusting the target configuration parameter of the pilot is required, where
the first feedback information is obtained after a communication peer decodes a data packet and obtains decoding related information.

In some embodiments, the first feedback information includes:

the decoding related information or indication information for adjusting target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

In some embodiments, the processor 2204 is further configured to:

in a case that the decoding related information is greater than a first preset threshold, determine that the target configuration parameter needs to be adjusted.

In some embodiments, the processor 2204 is further configured to:
adjust the target configuration parameter of the pilot based on a target configuration parameter table, where
the target configuration parameter table is specified in a protocol in advance.

In some embodiments, the processor 2204 is further configured to:
adjust the target configuration parameter of the pilot based on a preset adjustment value, where
the preset adjustment value is specified in a protocol in advance.

In some embodiments, the processor 2204 is further configured to:

increase target transmit power of the pilot based on the target configuration parameter table and a target length of the pilot.

In some embodiments, the processor 2204 is further configured to:

increase target transmit power of the pilot based on the preset adjustment value and a target length of the pilot.

In some embodiments, the processor 2204 is further configured to:

if determining, based on received second feedback information, that adjusting the target configuration parameter of the pilot is required, and determining that the target transmit power of the pilot is less than a second preset threshold, continue to adjust the target configuration parameter of the pilot, where the second preset threshold includes a preset value, or highest transmit power corresponding to the target length of the pilot in the target configuration parameter table.

In some embodiments, the processor 2204 is further configured to:

if determining, based on received second feedback information, that adjusting the target configuration parameter of the pilot is required, and determining that the target transmit power of the pilot is greater than or equal to a second preset threshold, increase the target length of the pilot.

In some embodiments, the processor 2204 is further configured to:

if determining, based on the received second feedback information, that adjusting the target configuration parameter of the pilot is required, continue to adjust the target configuration parameter of the pilot.

In some embodiments, the processor 2204 is further configured to:

decrease a target overlap-mapped pilot quantity based on the target configuration parameter table and a target length of the pilot.

In some embodiments, the processor 2204 is further configured to:

decrease a target overlap-mapped pilot quantity based on the preset adjustment value and a target length of the pilot.

In some embodiments, the processor 2204 is further configured to:

if determining, based on received third feedback information, that adjusting the target configuration parameter of the pilot is required, and determining that the target overlap-mapped pilot quantity is greater than a third preset threshold, continue to adjust the target configuration parameter of the pilot, where the third preset threshold includes a preset value, or a smallest overlap-mapped quantity corresponding to the target length of the pilot in the target configuration parameter table.

In some embodiments, the processor 2204 is further configured to:

if determining, based on received third feedback information, that adjusting the target configuration parameter of the pilot is required, and determining that the target overlap-mapped pilot quantity is less than or equal to a third preset threshold, increase the target length of the pilot.

In some embodiments, the processor 2204 is further configured to:

if determining, based on the received third feedback information, that adjusting the target configuration parameter of the pilot is required, continue to adjust the target configuration parameter of the pilot.

In some embodiments, the processor 2204 is further configured to:

indicate the target configuration parameter to the communication peer based on first indication information.

In some embodiments, the processor 2204 is further configured to:
multiplex an initial pilot and data on the pilot resource block for transmission, where
the initial pilot is obtained based on a configuration of an initial configuration parameter.

In some embodiments, the initial configuration parameter is preset, or the initial configuration parameter is selected from a target configuration parameter table.

In some embodiments, in a case that the target configuration parameter of the pilot includes the target length and target transmit power of the pilot, the initial configuration parameter includes a configuration parameter that causes the initial pilot to occupy fewest resources.

In some embodiments, in a case that the target configuration parameter of the pilot includes the target length of the pilot and the target overlap-mapped pilot quantity, the initial configuration parameter includes a first pilot length, and/or a first overlap-mapped quantity corresponding to the first pilot length, where

a pilot of the first pilot length occupies fewest resources; and the first overlap-mapped quantity is a largest overlap-mapped quantity corresponding to the first pilot length.

In some embodiments, the processor 2204 is further configured to:

indicate the initial configuration parameter and/or the target configuration parameter to the communication peer based on second indication information.

In some embodiments, the second indication information includes:
the initial configuration parameter and/or the target configuration parameter; or
first index information, where the first index information is used to indicate the initial configuration parameter and/or the target configuration parameter.

In some embodiments, the processor 2204 is further configured to:

determine a target shape of the pilot resource block.

In some embodiments, the target shape of the pilot resource block includes:

a closed graph enclosed by a curve or a broken line.

In some embodiments, the target shape of the pilot resource block is scaled based on a length and width of a resource grid in delay-Doppler domain.

In some embodiments, the processor 2204 is further configured to:

determine the target shape of the pilot resource block based on a width of a pilot guard band and the target length of the pilot.

In some embodiments, the width of the pilot guard band is obtained through calculation based on channel quality information.

In some embodiments, the processor 2204 is further configured to:
determine the target shape of the pilot resource block in a pilot resource block shape indication table based on the width of the pilot guard band and the target length of the pilot, where
in the pilot resource block shape indication table, the target shape of the pilot resource block corresponds to the width of the pilot guard band and the target length of the pilot.

In some embodiments, among shapes of all pilot resource blocks corresponding to the width of the pilot guard band and the target length of the pilot, the target shape occupies fewest pilot resource blocks.

In some embodiments, the processor 2204 is further configured to:

indicate the target shape of the pilot resource block to the communication peer based on third indication information.

In some embodiments, the third indication information includes:
the target shape of the pilot resource block, and the width of the pilot guard band and the target length of the pilot corresponding to the target shape of the pilot resource block in the pilot resource block shape indication table; or
second index information, where the second index information is used to indicate the target shape of the pilot resource block, and the width of the pilot guard band and the target length of the pilot corresponding to the target shape of the pilot resource block in the pilot resource block shape indication table.

In some embodiments, the processor 2204 is further configured to:

indicate the pilot resource block shape indication table to the communication peer based on fourth indication information.

In some embodiments, the processor 2204 is further configured to:
indicate, based on fifth indication information, that a first pilot adjustment process is to be triggered or stopped, where
the first pilot adjustment process includes: determining, based on the received first feedback information and/or second pilot information, that adjusting the target configuration parameter of the pilot is required.

In some embodiments, the processor 2204 is further configured to:
indicate a feedback period of the communication peer based on sixth indication information, where
the feedback period includes a time window for collecting statistics of the decoding related information and/or a transmission period of a feedback message.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

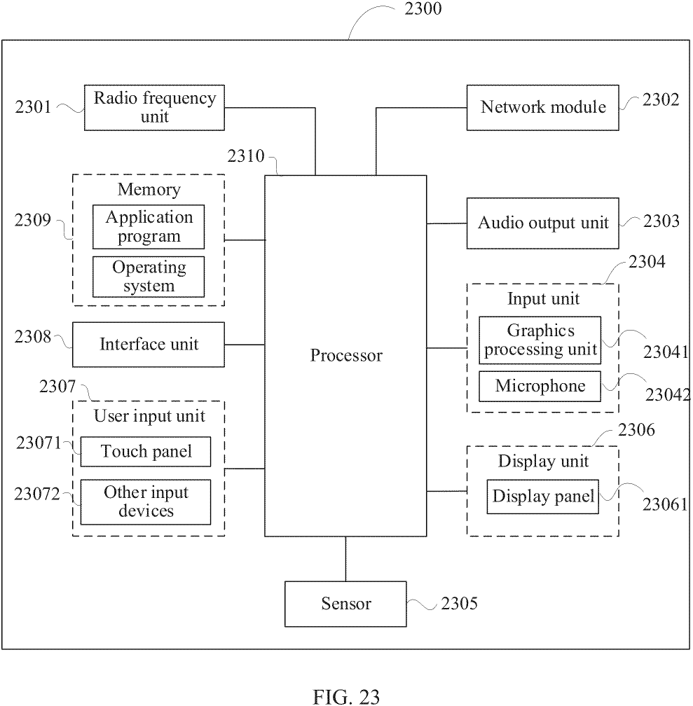

FIG. 23 is a schematic diagram of a hardware structure of a terminal according to an embodiment of this application.

The terminal 2300 includes but is not limited to components such as a radio frequency unit 2301, a network module 2302, an audio output unit 2303, an input unit 2304, a sensor 2305, a display unit 2306, a user input unit 2307, an interface unit 2308, a memory 2309, and a processor 2310.

A person skilled in the art may understand that the terminal 2300 may further include a power supply (for example, a battery) supplying power to all components. The power supply may be logically connected to the processor 2310 through a power management system. In this way, functions such as charge management, discharge management, and power consumption management are implemented by using the power management system. The terminal structure shown in FIG. 23 does not constitute a limitation on the terminal The terminal may include more or fewer components than those shown in the figure, or some components are combined, or component arrangements are different. Details are not described herein again.

It should be understood that, in this embodiment of this application, the input unit 2304 may include a Graphics Processing Unit (GPU) 23041 and a microphone 23042. The graphics processing unit 23041 processes image data of a still picture or video obtained by an image capture apparatus (such as a camera) in a video capture mode or an image capture mode. The display unit 2306 may include a display panel 23061, and the display panel 23061 may be configured in a form of a liquid crystal display, an organic light-emitting diode, or the like. The user input unit 2307 includes a touch panel 23071 and other input devices 23072. The touch panel 23071 is also referred to as a touchscreen. The touch panel 23071 may include two parts: a touch detection apparatus and a touch controller. The other input devices 23072 may include but are not limited to a physical keyboard, a function key (such as a volume control key or a switch key), a trackball, a mouse, and a joystick. Details are not described herein again.

In this embodiment of this application, the radio frequency unit 2301 sends, after receiving information from a communication peer, the information to the processor 2310 for processing, and in addition, sends to-be-transmitted information to the communication peer. Generally, the radio frequency unit 2301 includes but is not limited to an antenna, at least one amplifier, a transceiver, a coupler, a low noise amplifier, a duplexer, and the like.

The memory 2309 may be configured to store software programs or instructions and various data. The memory 2309 may primarily include a program or instruction storage area and a data storage area. The program or instruction storage area may store an operating system, an application program or instructions (such as an audio play function and an image play function) required by at least one function, and the like. In addition, the memory 2309 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 2310 may include one or more processing units. In some embodiments, the processor 2310 may integrate an application processor and a modem processor. The application processor mainly processes the operating system, a user interface, an application program, or an instruction. The modem processor mainly processes wireless communication. For example, the modem processor is a baseband processor. It may be understood that the modem processor may not be integrated in the processor 23 10.

The processor 2310 is configured to:
determine a target configuration parameter of a pilot; and
map, based on the target configuration parameter, the pilot to a pilot resource block in delay-Doppler domain for transmission.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

In some embodiments, the target configuration parameter of the pilot includes:

a target length of the pilot and target transmit power of the pilot.

In some embodiments, the target configuration parameter of the pilot includes:

a target length of the pilot and a target overlap-mapped pilot quantity.

In some embodiments, the processor 2310 is further configured to:
determine, based on received first feedback information, that adjusting the target configuration parameter of the pilot is required, where
the first feedback information is obtained after a communication peer decodes a data packet and obtains decoding related information.

In some embodiments, the first feedback information includes: the decoding related information or indication information for adjusting the target configuration parameter, where the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

In some embodiments, the processor 23 10 is further configured to:

in a case that the decoding related information is greater than a first preset threshold, determine that the target configuration parameter needs to be adjusted.

In some embodiments, the processor 2310 is further configured to:
adjust the target configuration parameter of the pilot based on a target configuration parameter table, where
the target configuration parameter table is specified in a protocol in advance.

In some embodiments, the processor 2310 is further configured to:
adjust the target configuration parameter of the pilot based on a preset adjustment value, where
the preset adjustment value is specified in a protocol in advance.

In some embodiments, the processor 2310 is further configured to:

increase target transmit power of the pilot based on the target configuration parameter table and a target length of the pilot.

In some embodiments, the processor 2310 is further configured to:

increase target transmit power of the pilot based on the preset adjustment value and a target length of the pilot.

In some embodiments, the processor 2310 is further configured to:

if determining, based on received second feedback information, that adjusting the target configuration parameter of the pilot is required, and determining that the target transmit power of the pilot is less than a second preset threshold, continue to adjust the target configuration parameter of the pilot, where the second preset threshold includes a preset value, or highest transmit power corresponding to the target length of the pilot in the target configuration parameter table.

In some embodiments, the processor 2310 is further configured to:

if determining, based on received second feedback information, that adjusting the target configuration parameter of the pilot is required, and determining that the target transmit power of the pilot is greater than or equal to a second preset threshold, increase the target length of the pilot.

In some embodiments, the processor 2310 is further configured to:

if determining, based on the received second feedback information, that adjusting the target configuration parameter of the pilot is required, continue to adjust the target configuration parameter of the pilot.

In some embodiments, the processor 2310 is further configured to:

decrease a target overlap-mapped pilot quantity based on the target configuration parameter table and a target length of the pilot.

In some embodiments, the processor 2310 is further configured to:

decrease a target overlap-mapped pilot quantity based on the preset adjustment value and a target length of the pilot.

In some embodiments, the processor 2310 is further configured to:

if determining, based on received third feedback information, that adjusting the target configuration parameter of the pilot is required, and determining that the target overlap-mapped pilot quantity is greater than a third preset threshold, continue to adjust the target configuration parameter of the pilot, where the third preset threshold includes a preset value, or a smallest overlap-mapped quantity corresponding to the target length of the pilot in the target configuration parameter table.

In some embodiments, the processor 2310 is further configured to:

if determining, based on received third feedback information, that adjusting the target configuration parameter of the pilot is required, and determining that the target overlap-mapped pilot quantity is less than or equal to a third preset threshold, increase the target length of the pilot.

In some embodiments, the processor 2310 is further configured to:

if determining, based on the received third feedback information, that adjusting the target configuration parameter of the pilot is required, continue to adjust the target configuration parameter of the pilot.

In some embodiments, the processor 2310 is further configured to:

indicate the target configuration parameter to the communication peer based on first indication information.

In some embodiments, the processor 23 10 is further configured to:
multiplex an initial pilot and data on the pilot resource block for transmission, where
the initial pilot is obtained based on a configuration of an initial configuration parameter.

In some embodiments, the initial configuration parameter is preset, or the initial configuration parameter is selected from a target configuration parameter table.

In some embodiments, in a case that the target configuration parameter of the pilot includes the target length and target transmit power of the pilot, the initial configuration parameter includes a configuration parameter that causes the initial pilot to occupy fewest resources.

In some embodiments, in a case that the target configuration parameter of the pilot includes the target length of the pilot and the target overlap-mapped pilot quantity, the initial configuration parameter includes a first pilot length, and/or a first overlap-mapped quantity corresponding to the first pilot length, where

a pilot of the first pilot length occupies fewest resources; and the first overlap-mapped quantity is a largest overlap-mapped quantity corresponding to the first pilot length.

In some embodiments, the processor 2310 is further configured to:

indicate the initial configuration parameter and/or the target configuration parameter to the communication peer based on second indication information.

In some embodiments, the second indication information includes:
the initial configuration parameter and/or the target configuration parameter; or
first index information, where the first index information is used to indicate the initial configuration parameter and/or the target configuration parameter.

In some embodiments, the processor 2310 is further configured to:

determine a target shape of the pilot resource block.

In some embodiments, the target shape of the pilot resource block includes:

a closed graph enclosed by a curve or a broken line.

In some embodiments, the target shape of the pilot resource block is scaled based on a length and width of a resource grid in delay-Doppler domain.

In some embodiments, the processor 2310 is further configured to:

determine the target shape of the pilot resource block based on a width of a pilot guard band and the target length of the pilot.

In some embodiments, the width of the pilot guard band is obtained through calculation based on channel quality information.

In some embodiments, the processor 2310 is further configured to:
determine the target shape of the pilot resource block in a pilot resource block shape indication table based on the width of the pilot guard band and the target length of the pilot, where
in the pilot resource block shape indication table, the target shape of the pilot resource block corresponds to the width of the pilot guard band and the target length of the pilot.

In some embodiments, among shapes of all pilot resource blocks corresponding to the width of the pilot guard band and the target length of the pilot, the target shape occupies fewest pilot resource blocks.

In some embodiments, the processor 2310 is further configured to:

indicate the target shape of the pilot resource block to the communication peer based on third indication information.

In some embodiments, the third indication information includes:
the target shape of the pilot resource block, and the width of the pilot guard band and the target length of the pilot corresponding to the target shape of the pilot resource block in the pilot resource block shape indication table; or
second index information, where the second index information is used to indicate the target shape of the pilot resource block, and the width of the pilot guard band and the target length of the pilot corresponding to the target shape of the pilot resource block in the pilot resource block shape indication table.

In some embodiments, the processor 2310 is further configured to:

indicate the pilot resource block shape indication table to the communication peer based on fourth indication information.

In some embodiments, the processor 2310 is further configured to:
indicate, based on fifth indication information, that a first pilot adjustment process is to be triggered or stopped, where
the first pilot adjustment process includes: determining, based on the received first feedback information and/or second pilot information, that adjusting the target configuration parameter of the pilot is required.

In some embodiments, the processor 2310 is further configured to:
indicate a feedback period of the communication peer based on sixth indication information, where
the feedback period includes a time window for collecting statistics of the decoding related information and/or a transmission period of a feedback message.

In this embodiment of this application, after the parameter of the pilot is configured, the pilot is mapped to the pilot resource block in delay-Doppler domain for transmission. Because impact of the parameter configuration of the pilot on pilot overheads and reliability is considered, the pilot overheads are reduced while service reliability is ensured.

An embodiment of this application further provides a readable storage medium. The readable storage medium stores a program or instructions. When the program or instructions are executed by a processor, each process of the foregoing pilot transmission method embodiment is implemented, with the same technical effect achieved. To avoid repetition, details are not described herein again.

The processor is a processor in the terminal in the foregoing embodiment. The readable storage medium includes a computer-readable storage medium, for example, a computer Read-Only Memory (ROM), a Random Access Memory (RAM), a magnetic disk, or an optical disc.

In addition, an embodiment of this application provides a chip. The chip includes a processor and a communication interface. The communication interface is coupled to the processor. The processor is configured to run a program or instructions on a network-side device to implement each process of the foregoing pilot transmission method embodiment, with the same technical effect achieved. To avoid repetition, details are not described herein again.

It should be understood that the chip provided in this embodiment of this application may also be referred to as a system-level chip, a system chip, a chip system, a system-on-chip, or the like.

An embodiment of this application provides a computer program product. The program product is stored in a non-volatile storage medium, and the program product is executed by at least one processor to implement each process of the foregoing method embodiment, with the same technical effect achieved. To avoid repetition, details are not described herein again.

An embodiment of this application provides a communication device, configured to perform each process of the foregoing method embodiment, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a ...” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may be implemented by using hardware. Based on such an understanding, the technical solutions of this application essentially or the part contributing to the prior art may be implemented in a form of a software product. The computer software product is stored in a storage medium (such as a ROM/RAM, a magnetic disk, or an optical disc), and includes several instructions for enabling a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific embodiments. The foregoing specific embodiments are merely illustrative rather than restrictive. Inspired by this application, a person of ordinary skill in the art can still derive a plurality of variations without departing from the essence of this application and the protection scope of the claims. All these variations shall fall within the protection scope of this application.

What is claimed is:

1. A pilot transmission method, performed by a target communication device, comprising:
determining a target configuration parameter of a pilot; and
mapping, based on the target configuration parameter, the pilot to a pilot resource block in a delay-Doppler domain for transmission.

2. The pilot transmission method according to claim 1, wherein:
when a communication peer of the target communication device is a network-side device, the target configuration parameter of the pilot comprises:
a target length of the pilot and target transmit power of the pilot; or
when a communication peer of the target communication device is a terminal, the target configuration parameter of the pilot comprises:
a target length of the pilot and a target overlap-mapped pilot quantity.

3. The pilot transmission method according to claim 1, further comprising:
determining, based on received first feedback information, that adjusting the target configuration parameter of the pilot is required,
wherein the first feedback information is obtained after a communication peer decodes a data packet and obtains decoding related information.

4. The pilot transmission method according to claim 3, wherein the first feedback information comprises:
the decoding related information or indication information for adjusting the target configuration parameter,
wherein the indication information for adjusting the target configuration parameter is obtained after the communication peer determines, based on the decoding related information, that the target configuration parameter needs to be adjusted, and the indication information for adjusting the target configuration parameter is used to indicate an adjustment of the target configuration parameter.

5. The pilot transmission method according to claim 4, wherein the determining, based on the decoding related information, that the target configuration parameter needs to be adjusted comprises:
when the decoding related information is greater than a first preset threshold, determining that the target configuration parameter needs to be adjusted.

6. The pilot transmission method according to claim 3, wherein the adjusting the target configuration parameter of the pilot comprises:
adjusting the target configuration parameter of the pilot based on a target configuration parameter table,
wherein the target configuration parameter table is specified in a protocol in advance.

7. The pilot transmission method according to claim 3, wherein the adjusting the target configuration parameter of the pilot comprises:
adjusting the target configuration parameter of the pilot based on a preset adjustment value,
wherein the preset adjustment value is specified in a protocol in advance.

8. The pilot transmission method according to claim 6, wherein:
when a communication peer of the target communication device is a network-side device, the adjusting the target configuration parameter of the pilot comprises:
increasing target transmit power of the pilot based on the target configuration parameter table and a target length of the pilot; or
when a communication peer of the target communication device is a terminal, the adjusting the target configuration parameter of the pilot comprises:
decreasing a target overlap-mapped pilot quantity based on the target configuration parameter table and a target length of the pilot.

9. The pilot transmission method according to claim 7, wherein:
when a communication peer of the target communication device is a network-side device, the adjusting the target configuration parameter of the pilot comprises:
increasing target transmit power of the pilot based on the preset adjustment value and a target length of the pilot; or
when a communication peer of the target communication device is a terminal, the adjusting the target configuration parameter of the pilot comprises:
decreasing a target overlap-mapped pilot quantity based on the preset adjustment value and a target length of the pilot.

10. The pilot transmission method according to claim 1, further comprising:
multiplexing an initial pilot and data on the pilot resource block for transmission,
wherein the initial pilot is obtained based on a configuration of an initial configuration parameter.

11. The pilot transmission method according to claim 10, wherein the initial configuration parameter is preset, or the initial configuration parameter is selected from a target configuration parameter table.

12. The pilot transmission method according to claim 11, wherein:
when the target configuration parameter of the pilot comprises the target length and target transmit power of the pilot, the initial configuration parameter comprises a configuration parameter that causes the initial pilot to occupy fewest resources; or
when the target configuration parameter of the pilot comprises the target length of the pilot and the target overlap-mapped pilot quantity, the initial configuration parameter comprises a first pilot length, or a first overlap-mapped quantity corresponding to the first pilot length,
wherein a pilot of the first pilot length occupies fewest resources; and the first overlap-mapped quantity is a largest overlap-mapped quantity corresponding to the first pilot length.

13. The pilot transmission method according to claim 10, further comprising:
indicating the initial configuration parameter or the target configuration parameter to the communication peer based on second indication information.

14. The pilot transmission method according to claim 13, wherein the second indication information comprises:
the initial configuration parameter or the target configuration parameter; or
first index information, wherein the first index information is used to indicate the initial configuration parameter or the target configuration parameter.

15. The pilot transmission method according to claim 1, further comprising:
determining a target shape of the pilot resource block.

16. The pilot transmission method according to claim 15, wherein the target shape of the pilot resource block comprises a closed graph enclosed by a curve or a broken line, and the target shape of the pilot resource block is scaled based on a length and width of a resource grid in the delay-Doppler domain.

17. The pilot transmission method according to claim 3, further comprising:
indicating, based on fifth indication information, that a first pilot adjustment process is to be triggered or stopped,
wherein the first pilot adjustment process comprises: determining, based on the received first feedback information or second pilot information, that adjusting the target configuration parameter of the pilot is required; or
indicating a feedback period of the communication peer based on sixth indication information,
wherein the feedback period comprises a time window for collecting statistics of the decoding related information or a transmission period of the first feedback information.

18. A target communication device, comprising:
a memory storing a computer program; and a processor coupled to the memory and configured to execute the computer program to perform operations comprising:
determining a target configuration parameter of a pilot; and
mapping, based on the target configuration parameter, the pilot to a pilot resource block in a delay-Doppler domain for transmission.

19. The target communication device according to claim 18, wherein:
when a communication peer of the target communication device is a network-side device, the target configuration parameter of the pilot comprises:
a target length of the pilot and target transmit power of the pilot; or
when a communication peer of the target communication device is a terminal, the target configuration parameter of the pilot comprises:
a target length of the pilot and a target overlap-mapped pilot quantity.

20. A non-transitory computer-readable storage medium, storing a computer program, when the computer program is executed by a processor of a target communication device, causes the processor to perform operations comprising:
determining a target configuration parameter of a pilot; and
mapping, based on the target configuration parameter, the pilot to a pilot resource block in a delay-Doppler domain for transmission.
